(19) United States
(12) Patent Application Publication
(10) Pub. No.: US 2006/0180464 A1
(43) Pub. Date: Aug. 17, 2006

(54) Apparatus and method for the controllable production of hydrogen at an accelerated rate

(76) Inventor: Linnard Griffin, Bertram, TX (US)

Correspondence Address: STORM L.L.P., BANK OF AMERICA PLAZA, 901 MAIN STREET, SUITE 7100, DALLAS, TX, 75202, US

(21) Appl. No.: 11/403,975

(22) Filed: Apr. 13, 2006

Related U.S. Application Data
(63) Continuation-in-part of application No. 11/060,960, filed on Feb. 18, 2005.
Application No. 11/060,960 is a continuation-in-part of application No. 10/919,755, filed on Aug. 17, 2004.
(60) Provisional application No. 60/671,664, filed on Apr. 15, 2005.
(60) Provisional application No. 60/678,614, filed on May 6, 2005.
(60) Provisional application No. 60/712,265, filed on Aug. 29, 2005.
(60) Provisional application No. 60/737,981, filed on Nov. 18, 2005.
(60) Provisional application No. 60/496,174, filed on Aug. 19, 2003.
(60) Provisional application No. 60/508,989, filed on Oct. 6, 2003.
(60) Provisional application No. 60/512,663, filed on Oct. 20, 2003.
(60) Provisional application No. 60/524,468, filed on Nov. 24, 2003.
(60) Provisional application No. 60/531,766, filed on Dec. 22, 2003.
(60) Provisional application No. 60/531,767, filed on Dec. 22, 2003.

(51) Int. Cl. C25B 11/00; H01M 4/02; H01M 8/06; C25B 1/02

(52) U.S. Cl. 204/280; 429/209; 429/21; 205/637

(57) ABSTRACT

An apparatus for the production of hydrogen is disclosed, the apparatus comprising some or all of the following features, as well as additional features as described and claimed: a reaction medium; an anode in contact with the reaction medium; a cathode in contact with the reaction medium, wherein the cathode is capable of being in conductive contact with the anode; a catalyst suspended in the reaction medium, wherein the catalyst has a high surface-area-to-volume ratio; a salt dissolved in the reaction medium; a second high surface-area-to-volume ratio catalyst; a conductive path connecting the anode and cathode; a controller in the conductive path; an energy source; a reaction vessel and an electrical power source configured to provide an electrical potential between the cathode and the anode. Also disclosed are a method for producing hydrogen; an electric power generator; and a battery.

This application claims priority from U.S. provisional application No. 60/671,664, filed Apr. 15, 2005; U.S. provisional application No. 60/678,614, filed May 6, 2005; U.S. provisional application No. 60/712,265, filed Aug. 29, 2005; and U.S. provisional application No. 60/737,981, filed Nov. 18, 2005. This application is also a continuation-in-part of application Ser. No. 11/060,960, filed Feb. 18, 2005, which is a continuation-in-part of application Ser. No. 10/919,755, filed Aug. 17, 2004, which claims priority to provisional application Ser. Nos. 60/496,174, filed Aug. 19, 2003; 60/508,989, filed Oct. 6, 2003; 60/512,663, filed Oct. 20, 2003; 60/524,468, filed Nov. 24, 2003; 60/531,766, filed Dec. 22, 2003; and 60/531,767, filed Dec. 22, 2003. Each of the applications listed above is hereby incorporated by reference for all purposes.

### TECHNICAL FIELD

The present invention is directed to a method and apparatus for the production of hydrogen gas from water.

### BACKGROUND

Dihydrogen gas, H₂, also referred to as hydrogen gas, diatomic hydrogen, or elemental hydrogen is a valuable commodity with many current and potential uses. Hydrogen gas may be produced by a chemical reaction between water and a metal or metallic compound. Very reactive metals react with mineral acids to produce a salt plus hydrogen gas. Equations 1 through 5 are examples of this process, where HX represents any mineral acid. HX can represent, for example HCl, HBr, HI, H₂SO₄, HNO₃, but includes all acids.
2Li+2HX→H₂+2LiX (1)
2K+2HX→H₂+2KX (2)
2Na+2HX→H₂+2NaX (3)
Ca+2HX→H₂+CaX₂ (4)
Mg+2HX→H₂+MgX₂ (5)

Each of these reactions take place at an extremely high rate due to the very high activity of lithium, potassium, sodium, calcium, and magnesium, which are listed in order of their respective reaction rates, with lithium reacting the fastest and magnesium reacting the most slowly of this group of metals. In fact, these reactions take place at such an accelerated rate that they have not been considered to provide a useful method for the synthesis of hydrogen gas in the prior art.

Metals of intermediate reactivity undergo the same reaction but at a much more controllable reaction rate. Equations 6 and 7 are examples, again where HX represents all mineral acids.
Zn+2HX→H₂+ZnX₂ (6)
2Al+6HX→3H₂+2AlX₃ (7)

Reactions of this type provide a better method for the production of hydrogen gas due to their relatively slower and therefore more controllable reaction rate. Metals like these have not, however, been used in prior art production of diatomic hydrogen because of the expense of these metals.

Iron reacts with mineral acids by either of the following equations:
Fe+2HX→H₂+FeX₂ (8)
or
2Fe+6HX→3H₂+2FeX₃ (9)

Due to the rather low activity of iron, both of these reactions take place at a rather slow reaction rate. The reaction rates are so slow that these reactions have not been considered to provide a useful method for the production of diatomic hydrogen in the prior art. Thus, while iron does provide the availability and low price needed for the production of elemental hydrogen, it does not react at a rate great enough to make it useful for hydrogen production.

Metals such as silver, gold, and platinum are not found to undergo reaction with mineral acids under normal conditions in the prior art.
Ag+HX→No Reaction (10)
Au+HX→No Reaction (11)
Pt+HX→No Reaction (12)

In neutral or basic solutions very reactive metals react with water to produce hydrogen gas plus a base. Equations 13-16 are examples of this process.
2Li+2H₂O→H₂+2LiOH (13)
2K+2H₂O→H₂+2KOH (14)
2Na+2H₂O→H₂+2NaOH (15)
Ca+2H₂O→H₂+Ca(OH)₂ (16)

Each of these reactions take place at an extremely high rate due to the very high activity of lithium, potassium, sodium, and calcium, which are listed in order of their respective reaction rates, with lithium reacting the fastest and calcium reacting the slowest of this group of metals. In fact, these reactions take place at such an accelerated rate that they do not provide a useful method for the synthesis of hydrogen gas.

Metals of intermediate reactivity undergo the same reaction in neutral or basic solution but heat must be supplied to promote these reactions. Equations 17-21 are examples of such a process.
Mg+2H₂O→H₂+Mg(OH)₂ (17)
2Al+6H₂O →3H₂+2Al(OH)₃ (18)
Zn+2H₂O→H₂+Zn(OH)₂ (19)
Fe+2H₂O→H₂+Fe(OH)₂ (20)
2Fe+6H₂O→3H₂+2Fe(OH)₃ (21)

While reactions of this type might seem to provide a better method for the production of hydrogen gas due to their relatively slower and therefore more controllable reaction rate, the high temperatures required for these reactions increase the cost of the process. Metals like these have therefore not been used in the production of diatomic hydrogen.

Accordingly, a need exists for a method and apparatus for the efficient production of hydrogen gas using relatively inexpensive metals.

### SUMMARY

It is a general object of the disclosed invention to provide a method and apparatus for the controllable production of hydrogen gas at an accelerated rate. This and other objects of the present invention are achieved by providing:

An apparatus for the production of hydrogen generally comprising a reaction medium; an anode in contact with the reaction medium; a cathode in contact with the reaction medium, wherein the cathode is capable of being in conductive contact with the anode; and a catalyst suspended in the reaction medium, wherein the catalyst has a high surface-area-to-volume ratio.

In an additional embodiment, the catalyst is a colloidal metal.

In a further additional embodiment, the catalyst has a surface-area-to-volume ratio of at least 298,000,000 m² per cubic meter.

In a further additional embodiment, a salt is dissolved in the reaction medium.

In a further additional embodiment, a cation of the salt is less reactive than a metal composing the anode.

In a further additional embodiment, a cation of the salt comprises zinc or cobalt.

In a further additional embodiment, the apparatus further comprises a second catalyst suspended in the reaction medium, wherein the second catalyst is a colloidal metal or has a surface-area-to-volume ratio of at least 298,000,000 m² per cubic meter.

In a further additional embodiment, the anode and cathode are connected via a conductive path.

In a further additional embodiment, the conductive path is hardwired to the cathode and the anode.

In a further additional embodiment, the apparatus further comprises a controller in the conductive path between the cathode and the anode, wherein the controller is configured to selectively allow or hinder the flow of electrical current between the cathode and the anode through the conductive path.

In a further additional embodiment, the reaction medium is an aqueous solution.

In a further additional embodiment, the reaction medium comprises an acid or a base.

In a further additional embodiment, the cathode comprises tungsten carbide or carbonized nickel.

In a further additional embodiment, the anode comprises aluminum.

In a further additional embodiment, the cathode comprises surface-area-increasing features.

In a further additional embodiment, the surface area of the cathode is greater than the surface area of the anode.

In a further additional embodiment, the apparatus further comprises an energy source configured to provide energy to the reaction medium.

In a further additional embodiment, a reaction vessel containing the reaction medium is configured to maintain an internal pressure above atmospheric pressure.

In a further additional embodiment, the apparatus further comprises an electrical power source configured to provide an electrical potential between the cathode and the anode.

Also disclosed is a battery with many of the above features.

Also disclosed is a method of producing hydrogen gas comprising the steps of: suspending a colloidal metal in a reaction medium; contacting the reaction medium with a cathode; contacting the reaction medium with an anode; and electrically connecting the cathode and the anode.

In an additional embodiment, the method further comprises the step of dissolving a salt in the reaction medium.

In an additional embodiment, the method further comprises the steps of: interrupting the conductive path between the anode and cathode; and providing an electrical potential between the anode and cathode.

In an additional embodiment, the method further comprises the step of adding energy to the reaction medium.

Also disclosed is a method of controlling the production of hydrogen generally comprising the steps of: suspending a colloidal metal in a reaction medium; contacting the reaction medium with a cathode; contacting the reaction medium with an anode; connecting the cathode and the anode via a conductive path; and varying the resistance along the conductive path.

Also disclosed is an electrical power generator generally comprising: a reaction vessel; a reaction medium contained within the reaction vessel; an anode in contact with the reaction medium; a cathode in contact with the reaction medium, wherein the cathode is in conductive contact with the anode; a catalyst metal in contact with the reaction medium, wherein the catalyst metal is in colloidal form or has a surface-area-to-volume ratio of at least 298,000,000 m2 per cubic meter; an outlet in the reaction vessel configured to allow hydrogen gas to escape from the reaction vessel; and a fuel cell configured to accept hydrogen has from the outlet and use the gas to produce an electric potential.

### BRIEF DESCRIPTION OF THE DRAWING

FIG. 1 is a diagram of a reactor for the production of hydrogen.

### DETAILED DESCRIPTION

Most metals can be produced in a colloidal state in an aqueous solution. A colloid is a material composed of very small particles of one substance that are dispersed (suspended), but not dissolved in solution. Thus, colloidal particles do not settle out of solution, even though they exist in the solid state. A colloid of any particular metal is then a very small particle of that metal suspended in a solution. These suspended particles of metal may exist in the solid (metallic) form or in the ionic form, or as a mixture of the two. The very small size of the particles of these metals results in a very large effective surface area for the metal. This very large effective surface area for the metal can cause the surface reactions of the metal to increase dramatically when it comes into contact with other atoms or molecules.

The catalysts used in the experiments described below are colloidal metals obtained using a colloidal silver machine, model: Hvac-Ultra, serial number: U-03-98-198, sold by CS Prosystems of San Antonio, Tex. The website of CS Prosystems is www.csprosystems.com. Colloidal solutions of metals that are produced using this apparatus result from an electrolytic process and are thought to contain colloidal particles, some of which are electrically neutral and some of which are positively charged. Other methods can be employed in the production of colloidal metal solutions. It is believed that the positive charge on the colloidal metal particles used in the experiments described below provides additional rate enhancement effects. It is still believed, however, that it is to a great extent the size and the resulting surface area of the colloidal particles that causes a significant portion of the rate enhancement effects that are detailed below, regardless of the charge on the colloidal particles. Based upon data provided by the manufacturer of the machine used, the particles of a metal in the colloidal solutions used in the experiments described below are believed to range in size between 0.001 and 0.01 microns. In such a solution of colloidal metals, the concentration of the metals is believed to be between about 5 to 20 parts per million.

Alternative to using a catalyst in colloidal form, it may be possible to use a catalyst in another form that offers a high surface-area-to-volume ratio, such as a porous solid, nanometals, colloid-polymer nanocomposites and the like. In general, the catalysts may be in any form with an effective surface area that preferably on the order of 298,000,000 m2 per cubic meter of catalyst, although smaller surface area ratios may also work.

Reactions In Acidic Media

Thus, when any metal, regardless of its normal reactivity, is used in its colloidal form, the reaction of the metal with mineral acids can take place at an accelerated rate. Equations 22-24 are thus general equations that are believed to occur for any metals in spite of their normal reactivity, where M represents any metal in colloidal form. M, for instance, can represent, but is not limited to, silver, copper, tin, zinc, lead, and cadmium. In fact, it has been found that the reactions shown in equations 22-24 occur at a significant reaction rate even in solutions of 1% aqueous acid.
2M+2HX→2MX+H₂ (22)
M+2HX→MX₂+H₂ (23)
2M+6HX→2MX₃+3H₂ (24)

Even though equations 22-24 represent largely endothermic processes for many metals, particularly those of low reactivity (for example, but not limited to, silver, gold, copper, tin, lead, and zinc), the rate of the reactions depicted in equations 22-24 is in fact very high due to the surface effects caused by the use of the colloidal metal. While the reactions portrayed in equations 22-24 take place at a highly accelerated reaction rate, these reactions do not result in a useful production of elemental hydrogen since the colloidal metal by definition is present in very low concentrations.

A useful preparation of hydrogen results, however, by the inclusion of a metal more reactive than the colloidal metal such as, but not limited to, metallic iron, metallic aluminum, or metallic nickel. Thus, any colloidal metal in its ionic form, M⁺, would be expected to react with the metal Mₑ as indicated in equation 25, where those metals M⁺ below Mₑ on the electromotive or activity series of metals would react best.
Mₑ+M⁺→M+Mₑ⁺ (25)

It is believed that the reaction illustrated by equation 25 takes place quite readily due to the large effective surface area of the colloidal ion, M⁺, and also due to the greater reactivity of the metal Mₑ compared to M⁺, which is preferably of lower reactivity. In fact, for metals normally lower in reactivity than Mₑ, equation 25 would result in a highly exothermic reaction. The metal, M, resulting from reduction of the colloidal ion, M⁺, would be present in colloidal quantities and thus, it is believed, undergoes a facile reaction with any mineral acid including, but not limited to, sulfuric acid, hydrochloric acid, hydrobromic acid, nitric acid, hydroiodic acid, perchloric acid, and chloric acid. However, the mineral acid is preferably sulfuric acid, H₂SO₄, or hydrochloric acid, HCl. Equation 26 describes this reaction where the formula HX (or H⁺+X⁻ in its ionic form) is a general representation for any mineral acid.
2M+2H⁺+2X⁻→2M⁺+H₂+2X⁻ (26)

While equation 26 represents an endothermic reaction, it is believed the exothermicity of the reactions in equation 25 compensates for this, making the combination of the two reactions energetically obtainable using the thermal energy supplied by ambient conditions. Of course the supply of additional energy accelerates the process.

Consequently, it is believed that elemental hydrogen is efficiently and easily produced by the combination of the reactions shown in equations 27 and 28.
4Mₑ+4M⁺→4M+4Mₑ⁺ (27)
4M+4H⁺+4X⁻→4M⁺+2H₂+4X⁻ (28)

Thus the metal Mₑ reacts with the colloidal metal ion in equation 27 to produce a colloidal metal and the ionic form of Mₑ. The colloidal metal will then react with a mineral acid in equation 28 to produce elemental hydrogen and regenerate the colloidal metal ion. The colloidal metal ion will then react again by equation 27, followed again by equation 28, and so on in a chain process to provide an efficient source of elemental hydrogen.

In principle, any colloidal metal ion should undergo this process successfully. It is found that the reactions work most efficiently when the colloidal metal is lower in reactivity than the metal Mₑ on the electromotive series table. The combining of equations 27 and 28 produces a net reaction that is illustrated by equation 29. Equation 29 has as its result the production of elemental hydrogen from the reaction of the metal Mₑ and a mineral acid.
4Mₑ+4M⁺→4M+4Mₑ⁺ (27)
+
4M+4H⁺+4X⁻→4M⁺+2H₂+4X⁻ (28)
=
4Mₑ+4H⁺→4Mₑ⁺+2H₂ (29)

Equation 29 summarizes a process that provides for very efficient production of elemental hydrogen where the metal Mₑ and acid are consumed. It is believed, however, that both the elemental metal Mₑ and the acid are regenerated as a result of a voltaic electrochemical process or thermal process that follows. It is believed that a colloidal metal Mᵣ (which can be the same one used in equation 27 or a different metal) can undergo a voltaic oxidation-reduction reaction indicated by equations 30 and 31.
Cathode (reduction) 4Mᵣ⁺+4e⁻→4Mᵣ (30)
Anode (oxidation) 2H₂O→4H⁺+O2+4e⁻ (31)

The colloidal metal Mᵣ can in principle be any metal, but reaction 30 progresses most efficiently when the metal has a higher (more positive) reduction potential. Thus, the reduction of the colloidal metal ion, as indicated in equation 30, takes place most efficiently when the colloidal metal is lower than the metal Mₑ on the electromotive series of metals. Consequently, any colloidal metal will be successful, but reaction 30 works best with colloidal metals such as colloidal silver or lead, due to the high reduction potential of these metals. When lead, for example, is employed as the colloidal metal ion in equations 30 and 31, the pair of reactions is found to take place quite readily. The voltaic reaction produces a positive voltage as the oxidation and reduction reactions take place. This positive voltage can be used to supply the energy required for other chemical processes. In fact, the voltage produced can even be used to supply an over potential for reactions employing equations 30 and 31 taking place in another reaction vessel. Thus, this electrochemical process can be made to take place more quickly without the supply of an external source of energy. The resulting colloidal metal, Mᵣ, can then react with oxidized ionic metal, Mₑ⁺, as indicated in equation 32, which would result in the regeneration of the metal, Mₑ, and the regeneration of the colloidal metal in its oxidized form.
4Mₑ⁺+4Mᵣ→4Mᵣ⁺+4Mₑ (32)

The reaction described by equation 32 could in fact occur using as starting material any colloidal metal, but will take place most effectively when the colloidal metal, Mᵣ, appears above the metal, Mₑ, on the electromotive series. The combining of equations 30-32 results in equation 33 which represents the regeneration of the elemental metal, Mₑ, the regeneration of the acid, and the formation of elemental oxygen.
4Mᵣ⁺+4e⁻→4Mᵣ (30)
+
2H₂O→4H⁺+O2+4e⁻ (31)
+
4Mₑ⁺+4Mᵣ→4Mᵣ⁺+4Mₑ (32)
=
4Mₑ⁺+2H₂O→4H⁺+4Mₑ+O₂ (33)

It is believed that the reaction shown in equations 30 and 31 occur best when the colloidal metal, Mᵣ, is as low as possible on the electromotive series of metals; however, it is believed that the reaction depicted by equation 32 takes place most efficiently when the colloidal metal, Mᵣ, is as high as possible on the electromotive series of metals. The net reaction illustrated by equation 33, which is merely the sum of equations 30, 31, and 32, could in fact be maximally facilitated by either colloidal metals of higher activity or by colloidal metals of lower activity. The relative importance of the reaction illustrated by equations 30 and 31 compared to the reaction shown in equation 32 would determine the characteristics of the colloidal metal that would best assist the net reaction in equation 33. It has been found that the net reaction indicated in equation 33 proceeds at a maximal rate when the colloidal metal is of higher activity, that is, when the colloidal metal is higher on the electromotive series of metals. It has been found that the more reactive colloidal metals such as, but not limited to, colloidal magnesium ion or colloidal aluminum ion produce the most facile processes for the reduction of cationic metals.

The combination of equations 29 and 33 results in a net process indicated in equation 34. As discussed above, the reaction depicted in equation 30 proceeds most efficiently when the colloidal metal is found below the metal, Mₑ, on the electromotive series. However, the reaction represented by equation 32 is most favorable when the colloidal metal is found above the metal, Mₑ, on the electromotive series. Accordingly, it has been observed that the concurrent use of two colloidal metals, one above the metal, Mₑ, and one below it in the electromotive series—for example, but not limited to, colloidal lead and colloidal aluminum—produces optimum results in terms of the efficiency of the net process. Since equation 34 merely depicts the decomposition of water into elemental hydrogen and elemental oxygen, the complete process for the production of elemental hydrogen now has only water as an expendable substance, and the only necessary energy source is supplied by ambient thermal conditions.
4Mₑ+4H⁺→4Mₑ⁺+2H₂ (29)
+
4Mₑ⁺+2H₂O→4H⁺+4Mₑ+O2 (33)
=
2H₂O→2H₂+O2 (34)

The net result of this process is exactly that which would result from the electrolysis of water. Here, however, no electrical energy needs to be supplied. Although the providing of additional energy would result in an enhanced rate of hydrogen formation, the reaction proceeds efficiently when the only energy supplied is ambient thermal energy. When additional energy is supplied, it can be supplied in the form of thermal energy, solar energy, electrical energy, radiant energy or other energy forms. When the additional energy supplied is thermal in nature, the maximum temperature achievable at atmospheric pressure is the boiling point of the solution; in aqueous systems this would be approximately a temperature of 100° C. At pressures greater than one atmosphere, however, temperatures higher than 100° C. could be obtained, and would provide an even more enhanced rate of hydrogen production. Therefore, when the additional energy supplied is in the form of thermal energy, it may be preferable to use a reaction vessel configured to maintain internal pressures greater than the prevailing atmospheric pressure, in order increase the boiling point of the solution and increase the amount of thermal energy that can be supplied. The colloidal metallic ion catalysts M⁺ and/or Mᵣ⁺ as well as the metal Mₑ and the acid are regenerated in the process, leaving only water as a consumable material.

Elemental Nonmetal

A further means by which the rate of hydrogen production could be increased involves the inclusion of a nonmetal in the reaction such as, but not limited to, carbon or sulfur. Using the symbol Z to represent the nonmetal, equation 31 would be replaced by equation 35 which portrays a more facile reaction due to the thermodynamic stability of the oxide of the nonmetal.
2H₂O+Z→4H⁺+ZO₂+4e⁻ (35)

Equation 33 would then be replaced by equation 36, and equation 34 would be replaced by equation 37.
4Mₑ⁺+2H₂O+Z→4H⁺+4Mₑ+ZO₂ (36)
2H₂O+Z→2H₂+ZO₂ (37)
Thus, rather than resulting in the formation of elemental oxygen, O₂, the reaction would produce an oxide such as CO₂ or SO₂ of a nonmetal, where the thermodynamic stability of the nonmetal oxide would provide an additional driving force for the reaction and thus result in an even faster rate of hydrogen production.
Reducing Agents

An alternative to the above process involves the introduction of a reducing agent such as hydrogen peroxide to react in the place of water. Thus, the reactions illustrated in equations 31 and 32 would be replaced by similar reactions illustrated by equations 38 and 39. The net result of these two reactions would be the reaction represented in equation 40, the production of elemental hydrogen using an elemental metal Mₑ and a mineral acid as reactants.
2Mₑ+2M⁺→2M+2Mₑ⁺ (38)
+
2M+2H⁺+2X⁻→2M⁺¹+H₂+2X⁻ (39)
=
2Mₑ+2H⁺→2Mₑ⁺+H₂ (40)

The elemental metal, Mₑ, as well as the mineral acid, would then be regenerated as a result of a different voltaic electrochemical process followed by a thermal reaction. Again, a colloidal metal, Mᵣ, reacts with hydrogen peroxide in an oxidation-reduction reaction indicated by equations 41 and 42.
Cathode (reduction) 2Mᵣ⁺+2e⁻→2Mᵣ (41)
Anode (oxidation) H₂O₂→2H⁺+O₂+2e⁻ (42)

Due to the fact that hydrogen peroxide has a larger (less negative) oxidation potential than water, as shown in the standard oxidation potentials listed below, the oxidation-reduction reaction resulting from equations 41 and 42 takes place at an enhanced rate compared to the oxidation-reduction reaction indicated by equations 30 and 31.
2H₂O→4H⁺+O₂+4e⁻ε⁰ oxidation=−1.229V
H₂O₂→2H⁺+O₂+2e⁻ε⁰ oxidation=−0.695V

The colloidal metal, Mᵣ, can, in principle, be any metal but works most efficiently when the metal has a high (more positive) reduction potential. Thus, the regeneration process takes place most efficiently when the colloidal metal is as low as possible on the electromotive series of metals. Consequently, any colloidal metal will be successful, but the reaction works well with colloidal silver ion, for example, due to the high reduction potential of silver. When silver is employed as the colloidal metal ion in equations 41 and 42, the pair of reactions is found to take place readily. The voltaic reaction produces a positive voltage as the oxidation and reduction reactions indicated take place. This positive voltage can be used to supply the energy required for other chemical processes. In fact, the voltage produced can even be used to supply an over-potential for reactions employing equations 41 and 42 taking place in another reaction vessel. Thus, this electrochemical process can be made to take place more quickly without the supply of an external source of energy. The resulting colloidal metal, Mᵣ, will then react to regenerate the metal, Mₑ (equation 43).
2Mₑ⁺+2Mᵣ→2Mᵣ⁺+2 (43)

The reaction illustrated by equation 43 will take place most efficiently when the colloidal metal, Mᵣ, is more reactive than the metal, Mₑ. That is, the reaction in equation 43 will proceed most efficiently when the colloidal metal, Mᵣ, is above the metal, Mₑ, on the electromotive series of metals. The combining of equations 41-43 results in equation 44 which represents the regeneration of the elemental metal, Mₑ, the regeneration of the acid, and the formation of elemental oxygen.
2Mᵣ⁺+2e⁻→2Mᵣ (41)
+
H₂O₂→2H⁺+O₂+2e⁻ (42)
+
2Mₑ⁺+2Mᵣ→2Mᵣ⁺+2Mₑ (43)
=
2Mₑ⁺+H₂O₂→2H⁺+2Mₑ+O₂ (44)

The reactions shown in equations 41 and 42 seem to occur best when the colloidal metal, Mᵣ, is as low as possible on the electromotive series of metals; however, the reaction depicted by equation 43 takes place most efficiently when the colloidal metal, Mᵣ, is as high as possible on the electromotive series of metals. The net reaction illustrated by equation 44, which is merely the sum of equations 41, 42, and 43, could in fact be facilitated by either colloidal metals of higher activity or lower activity than Mₑ. The relative importance of the reaction illustrated by equations 41 and 42 compared to the reaction shown in equation 43 would determine the characteristics of the colloidal metal that would best assist the net reaction in equation 44. It has been found that the net reaction indicated in equation 44 proceeds at a maximal rate when the colloidal metal is of higher activity, that is, when the colloidal metal is as high as possible on the electromotive series of metals. It has been found that the more reactive colloidal metals such as, but not limited to, colloidal magnesium ion and colloidal aluminum ion produce the most facile reduction processes for the reduction of cationic metals.

The combination of equations 40 and 44 results in the net process indicated in equation 45. Since equation 45 merely depicts the decomposition of hydrogen peroxide into elemental hydrogen and elemental oxygen, the complete process for the production of elemental hydrogen now has only hydrogen peroxide as an expendable substance, and the only necessary energy source is supplied by ambient thermal conditions.
2Mₑ+2H⁺→2Mₑ⁺+H₂ (40)
+
2Mₑ⁺+H₂O₂→2H⁺+2Mₑ+O₂ (44)
=
H₂O₂→H₂+O₂ (45)

Since the rate of regeneration of the metal, Mₑ, and the mineral acid are significantly lower than the rate of oxidation of the metal, Mₑ, by a mineral acid, it is the regeneration of the metal, Mₑ, and the mineral acid that proves to be rate-determining in this process. Since the oxidation of hydrogen peroxide (equation 42) is more favorable than the oxidation of water (equation 31), the rate of hydrogen formation is significantly enhanced when hydrogen peroxide is used in the place of water. This, of course, must be balanced by the fact that hydrogen peroxide is obviously a more costly reagent to supply, and that the ratio of elemental hydrogen to elemental oxygen becomes one part hydrogen to one part oxygen as indicated in equation 45. This would differ from the ratio of two parts hydrogen to one part oxygen as found in equation 34, where water is oxidized. In cases where the rate of hydrogen production is the more critical factor, the use of hydrogen peroxide will offer a significant advantage.

A further means by which the rate of hydrogen production could be increased would involve the inclusion of a nonmetal in the reaction such as, but not limited to, carbon or sulfur. Using the symbol Z to represent the nonmetal, equation 42 would be replaced by equation 46 which portrays a more facile reaction due to the thermodynamic stability of the oxide of the nonmetal.
H₂O₂+Z→2H⁺+ZO₂+2e⁻ (46)
Equation 44 would then be replaced by equation 47, and equation 45 would be replaced by equation 48.
2Mₑ⁺+H₂O₂+Z→2H⁺+2Mₑ+ZO₂ (47)
H₂O₂+Z→H₂+ZO₂ (48)

Thus, rather than resulting in the formation of elemental oxygen, O₂, the reaction would produce an oxide such as CO₂ or SO₂ of a nonmetal, where the thermodynamic stability of the nonmetal oxide would provide an additional driving force for the reaction, and thus result in an even faster rate of hydrogen production.

A further alternative to this process involves the introduction of other reducing agents, such as formic acid, to react in the place of water or hydrogen peroxide. Thus, the reactions illustrated in equations 31 and 32 would be replaced by similar reactions illustrated by equations 38 and 39. The net result of these two reactions would be the reaction represented in equation 40, the production of elemental hydrogen using an elemental metal, Mₑ, and a mineral acid as reactants.
2Mₑ+2M⁺→2M+2Mₑ⁺ (38)
+
2M+2H⁺+2X^{-→2}M⁺¹+H₂+2X⁻ (39)
=
2Mₑ+2H⁺→2Mₑ⁺+H₂ (40)

The elemental metal, Mₑ, as well as the mineral acid would then be regenerated as a result of a different voltaic electrochemical process followed by a thermal reaction. In this case, however, the colloidal metal, Mᵣ, reacts with formic acid in an oxidation-reduction reaction indicated by equations 41 and 49.
Cathode (reduction) 2Mᵣ⁺+2e⁻→2Mᵣ (41)
Anode (oxidation) CH₂O₂→2H⁺+CO₂+2e⁻ (49)

Due to the fact that formic acid has a very favorable positive oxidation potential compared to the negative ones reported for water and for hydrogen peroxide, as shown by the standard oxidation potentials listed below, the oxidation-reduction reaction resulting from equations 41 and 49 takes place at an enhanced rate compared to the oxidation-reduction reaction indicated by equations 30 and 31, or the oxidation-reduction reaction indicated by equations 41 and 42.
2H₂O→4H⁺+O₂+4e⁻ε⁰oxidation=−1.229V
H₂O₂→2H⁺+O₂+2e⁻ε⁰oxidation=−0.695V
CH₂O₂→2H⁺+CO₂+2e⁻ε⁰oxidation=0.199V

The colloidal metal, Mᵣ, can in principle be any metal but works most efficiently when the metal has a high (more positive) reduction potential. Thus, the regeneration process takes place most efficiently when the colloidal metal is as low as possible on the electromotive series of metals. Consequently, any colloidal metal will be successful, but the reaction works well with colloidal silver ion, for example, due to the high reduction potential of silver. When silver is employed as the colloidal metal ion in equations 41 and 49, the pair of reactions is found to take place quite readily. The voltaic reaction produces a positive voltage as the oxidation and reduction reactions indicated take place. This positive voltage can be used to supply the energy required for other chemical processes. In fact, the voltage produced can even be used to supply an over-potential for reactions employing equations 41 and 49 taking place in another reaction vessel. Thus, this electrochemical process can be made to take place more quickly without the supply of an external source of energy. The resulting colloidal metal, Mᵣ, will then react to regenerate the metal, Mₑ (equation 43).
2Mₑ⁺+2Mᵣ→2Mᵣ⁺+2Mₑ (43)

The reaction illustrated by equation 43 will take place most efficiently when the colloidal metal, Mᵣ, is more reactive than the metal, Mₑ. That is, the reaction in equation 43 will proceed most efficiently when the colloidal metal, Mᵣ, is above the metal, Mₑ, on the electromotive series of metals. The combining of equations 41, 49 and 43 produces the net reaction shown by equation 50. The net reaction represented by equation 50 results in the regeneration of the elemental metal, Mₑ, the regeneration of the acid, and the formation of carbon dioxide.
2Mᵣ⁺+2e⁻→2Mᵣ (41)
+
CH₂O₂→2H⁺+CO₂+2e⁻ (49)
+
2Mₑ⁺+2Mᵣ→2Mᵣ⁺+2Mₑ (43)
=
2Mₑ⁺+CH₂O₂→2H⁺+2Mₑ+CO₂ (50)

The reactions shown in equations 41 and 49 seem to occur best when the colloidal metal, Mᵣ, is as low as possible on the electromotive series of metals. However, the reaction depicted by equation 43 takes place most efficiently when the colloidal metal, Mᵣ, is as high as possible on the electromotive series of metals. The net reaction illustrated by equation 50, which is merely the sum of equations 41, 49, and 43, could, in fact, be maximally facilitated by either colloidal metals of higher activity or by colloidal metals of lower activity. The relative importance of the reaction illustrated by equations 41 and 49 compared to the reaction shown in equation 43 would determine the characteristics of the colloidal metal that would best assist the net reaction in equation 50. It has been found that the net reaction indicated in equation 50 proceeds at a maximal rate when the colloidal metal is of maximum activity, that is, when the colloidal metal is as high as possible on the electromotive series of metals. It has been found that the more reactive colloidal metals such as, but not limited to, colloidal magnesium ion and colloidal aluminum ion, produce the most facile reduction processes for the reduction of the cationic metals.

The combination of equations 40 and 50 results in a net process indicated in equation 51. Since equation 51 merely depicts the decomposition of formic acid into elemental hydrogen and carbon dioxide, the complete process for the production of elemental hydrogen now has only formic acid as an expendable substance, and the only necessary energy source is supplied by ambient thermal conditions. Although the providing of additional energy would result in an enhanced rate of hydrogen formation, the reaction proceeds efficiently when the only energy supplied is ambient thermal energy.
2Mₑ+2H⁺→2Mₑ⁺+H₂ (40)
+
2Mₑ⁺+CH₂O₂→2H⁺+2Mₑ+CO₂ (50)
=
CH₂O₂→H₂+CO₂ (51)

Since the regeneration of the metal, Mₑ, and the mineral acid are significantly lower with respect to reaction rate than the oxidation of the metal, Mₑ, by a mineral acid, it is the regeneration of the metal, Mₑ, and the mineral acid that is believed to be rate determining in this process. Since the oxidation of formic acid (equation 49) is more favorable than the oxidation of water (equation 31), or the oxidation of hydrogen peroxide (equation 42), the rate of hydrogen formation is significantly enhanced when formic acid is used in the place of water or in the place of hydrogen peroxide. This, of course, must be balanced by the facts that formic acid is a more costly reagent than water, but a less costly one than hydrogen peroxide, and that the co-product formed along with hydrogen is carbon dioxide rather than oxygen. Additionally, the ratio of elemental hydrogen to carbon dioxide is one part hydrogen to one part carbon dioxide, as indicated in equation 51. This would differ from the ratio of two parts hydrogen to one part oxygen, as found in equation 34, where water is oxidized. In cases, however, where the rate of hydrogen production is the most critical factor, the use of formic acid will offer a significant advantage.

Multiple Metals

Finally, while all equations depicted here involve the use of just a single metal, Mₑ, in addition to the colloidal metal(s) M and/or Mᵣ, it has been found that all of the reactions discussed herein can be carried out using a combination of two or more different metals in the place of the single metal, Mₑ, along with one or more colloidal metal(s). It has been found, in fact, that in some cases the use of multiple metals results in a significant rate enhancement over a rather large period of time. In experiments #7 and #10, for example, both metallic iron and metallic aluminum are used. The steady state production of hydrogen that results from experiment #10, for example, is approximately 100 mL of hydrogen per minute with the total volume of the reaction vessel being just over 100 mL. In experiments #8 and #9, similar reactions are carried out with just a single metal, aluminum, and it is demonstrated that when the reaction rate decreases, the addition of the second metal, iron, results in an immediate rate increase to a rate similar to those reactions where the two metals were present throughout the reaction.

Reactions in Neutral or Basic Media

When any metal, regardless of its normal reactivity, is used in its colloidal form, the reaction of the metal with water in neutral or basic solutions can take place at an accelerated rate. Equations 52-54 are general equations that can be made to occur for any metals in spite of their normal reactivity, where M_{f} represents any metal in colloidal form. M_{f}, for instance, can represent but is not limited to Ag, Cu, Sn, Zn, Pb, Mg, Fe, Al and Cd. In fact, it has been found that the reactions shown in equations 52-54 occur at a significant rate.
2M_{f}+2H₂O→2M_{f}OH+H₂ (52)
M_{f}+2H₂O→M_{f}(OH)₂+H₂ (53)
2M_{f}+6H₂O→2M_{f}(OH)₃+3H₂ (54)

Even though equations 52-54 would represent largely endothermic processes for a great many metals, particularly those of traditional low reactivity (for example but not limited to silver, gold, copper, tin, lead, nickel, and zinc), the rates of the reactions depicted in equations 52-54 could in fact be very large due to the surface effects caused by the use of the colloidal metal. While reactions represented by equations 52-54 would take place at a highly accelerated rate, they would not result in a useful production of elemental hydrogen since the colloidal metal by definition is present in very low concentrations, and would therefore yield insignificant amounts of hydrogen upon reaction.

A useful preparation of hydrogen can result by the inclusion of a solid metal, Mₛ, more reactive than the colloidal metal, M_{f}, such as but not limited to elemental aluminum, iron, lead, nickel, tin, tungsten, or zinc. Thus any colloidal metal in its ionic form would be expected to react with the solid metal, Mₛ, as indicated in equation 55, where those metals below Mₛ on the electromotive or activity series of metals would react best.
Mₛ+M_{f}⁺→M_{f}+Mₛ⁺ (55)

The reaction illustrated by equation 55 would in fact take place quite readily due to the large effective surface area of the colloidal ion, M_{f}⁺, and also perhaps due to the greater reactivity of the solid metal Mₛ, compared to any metal of lower reactivity. In fact, for colloidal metals normally lower in reactivity than Mₛ, equation 55 would be an exothermic reaction. The resulting metal, M_{f}, would be theorized to be present in colloidal form and thus would undergo a facile reaction with water to produce elemental hydrogen and a base, either by equation 52, 53, or 54 depending upon the oxidation state of the resulting colloidal metal ion.

Although the reaction represented by equations 52, 53, or 54 would most likely be endothermic, it is believed that the exothermicity of the reaction shown in equation 55 compensates for this. Therefore, the combination of the two reactions yields a process that is thermally obtainable.

Consequently, elemental hydrogen is efficiently and easily produced by the combination of the reactions shown in equations 56 and 57.
4Mₛ+4M_{f}^{+→4}M_{f}+4Mₛ⁺ (56)
4M_{f}+4H₂O→4M_{f}⁺¹+2H₂+4OH⁻ (57)

As shown, the solid metal, Mₛ, reacts with the colloidal metal ion (equation 56) to produce a product theorized to be a colloidal metal. It is believed the colloidal metal will then react with water in equation 57 to produce elemental hydrogen and regenerate the colloidal metal ion. The colloidal metal ion will then react again by equation 56, followed again by equation 57, and so on in a chain reaction process to provide an efficient source of elemental hydrogen. In principle, any colloidal metal ion should undergo this process successfully. It is found that the reaction works most efficiently when the colloidal metal ion is lower in reactivity than the metal, Mₛ, on the electromotive series table. Equations 56 and 57 can be combined, and this would result in the net reaction that is illustrated by equation 58. Equation 58 has as its result the production of elemental hydrogen from the reaction of a metal, Mₛ, and water.
4Mₛ+4M_{f}^{+→4}M_{f}+4Mₛ⁺ (56)
+
4M_{f}+4H₂O→4M_{f}⁺¹+2H₂+4OH⁻ (57)
=
4Mₛ+4H₂O→4Mₛ⁺+2H₂+4OH⁻ (58)

Equation 58 summarizes a process that can provide an efficient production of elemental hydrogen where an elemental metal, Mₛ, and water are consumed. It is believed, however, that the elemental metal can be regenerated as a result of a voltaic electrochemical process and a thermal process that follows. A colloidal metal, which can be the same or different from the one represented in equation 56 referred to as Mᵣₛ in equation 59, can undergo a voltaic oxidation-reduction reaction indicated by equations 59 and 60.
Cathode (reduction) 4Mᵣₛ⁺+4e⁻→4Mᵣₛ (59)
Anode (oxidation) 4OH⁻→2H₂O+O₂+4e⁻ (60)

The colloidal metal, Mᵣₛ, can in principle be any metal but works most efficiently when the metal has a higher (more positive) reduction potential. Thus, the regeneration process takes place most efficiently when the colloidal metal is as low as possible on the electromotive series of metals. Consequently, any colloidal metal will be successful, but the reaction works best with colloidal silver ion, due to the high reduction potential of silver. When silver is employed as the colloidal metal ion, for example, the reactions portrayed in equations 59 and 60 take place readily. The voltaic reaction produces a positive voltage, as the indicated oxidation and reduction reactions occur. This positive voltage can be used to supply the energy required for other chemical processes. In fact, the voltage produced can even be used to supply an over-potential for reactions employing the conversions portrayed by equations 59 and 60 but taking place in another reaction vessel. Thus, this electrochemical process can be made to take place more quickly without the supply of an external source of energy. It is believed that the resulting colloidal metal, Mᵣₛ, may then react to regenerate the elemental metal, Mₛ (equation 61).
4Mₛ⁺+4Mᵣₛ→4Mᵣₛ⁺+4Mₛ (61)

The reaction illustrated by equation 61 will take place most efficiently when the colloidal metal, Mᵣₛ, is more reactive than the metal, Mₛ. That is, the reaction in equation 61 will proceed most readily when the colloidal metal, Mᵣₛ, is above the metal, Mₛ, on the electromotive series of metals. Combining equations 59-61 results in the chemical reaction represented by equation 62, which results in the regeneration of the elemental metal Mₛ, and the formation of elemental oxygen.
4Mᵣₛ⁺+4e⁻→4Mᵣₛ (59)
+
4OH⁻→2H₂O+O₂+4e⁻ (60)
+
4Mₛ⁺+4Mᵣₛ→4Mᵣₛ⁺+4Mₛ (61)
=
4Mₛ⁺+4OH⁻→2H₂O+4Mₛ+O₂ (62)

The reactions shown in equations 59 and 60 seem to occur best when the colloidal metal, Mᵣₛ, is as low as possible on the electromotive series of metals; however, the reaction depicted by equation 61 takes place most efficiently when the colloidal metal, Mᵣₛ, is as high as possible on the electromotive series of metals. The net reaction illustrated by equation 62 is merely the sum of equations 59, 60, and 61 and could be maximally facilitated by either colloidal metals of higher activity or by colloidal metals of lower activity. The relative importance of the reaction illustrated by equations 59 and 60 compared to the reaction shown in equation 61 would determine the characteristics of the colloidal metal that would best assist the net reaction in equation 62.

It has been found that the net reaction indicated in equation 62 proceeds at a maximal rate when the colloidal metal is of maximum activity, that is, when the colloidal metal is as high as possible on the electromotive series of metals. It has been found that the more reactive colloidal metal ions such as, but not limited to colloidal magnesium ion or colloidal aluminum ion produce the most facile processes for the reduction of cationic metals. In fact, it has been found that the overall reaction proceeds most efficiently when at least two colloidal metals are present, preferably where at least one of the colloidal metal ions is higher than the solid metal Mₑ on the electromotive series, and at least one of the colloidal metal ions is lower than the solid metal Mₑ on the electromotive series. In such case, it is believed that the less reactive colloidal metal performs the M_{f} functions described above, while the more reactive colloidal metal performs the Mᵣₛ functions.

Combining equations 58 and 62 results in a net process indicated in equation 34. Since equation 34 merely depicts the decomposition of water into elemental hydrogen and elemental oxygen, the complete process for the production of elemental hydrogen now has only water as an expendable substance.
4Mₛ+4 H₂O→4Mₛ⁺+2H₂+4OH⁻ (58)
+
4Mₛ⁺+4OH⁻→2H₂O+4Mₛ+O₂ (62)
=
2H₂O→2H₂+O₂ (34)

The net result of this process is exactly that which would result from the electrolysis of water. Here, however, no electrical energy needs to be supplied. It is believed that the colloidal metallic ion catalysts, as well as the metal Mₑ, are regenerated during the process, leaving only water as a consumable material.

Controllable Reactions

While all of the processes described above can provide an efficient production of hydrogen gas at a wide range of pH levels, and most operate efficiently even at ambient temperatures, it is rather difficult to control the rate of hydrogen formation; that is, once the process has begun, it cannot conveniently be stopped and restarted as needed. An improvement that addresses this difficulty has been developed that uses two electrodes, an anode and a cathode, along with one or more colloidal metal catalysts. The best results have been found when the anode is a metal of low to intermediate reactivity and the cathode is generally inert, but highly conductive. It has been found, in fact, that even metallic-like materials such as tungsten carbide can be employed as the cathode. Additionally, significant rate enhancement has also been achieved using, as the cathode, nickel which has been melted with an acetylene torch with a carbonizing flame and then re-solidified. This process is believed to result in carbonized nickel.

While in theory any two metals of different reactivity can be employed along with any colloidal metal catalysts at any level of pH, the process will be illustrated in the form of reactions performed at ambient temperature, under basic conditions using the metal-like material tungsten carbide as the cathode, the metal zinc as the anode, and colloidal silver and colloidal magnesium. Similar results were obtained for reactions carried out in acidic media as described in experiments 19-21.

Zinc is known to undergo reaction under basic conditions with water according to the reaction represented by equation 19.
Zn+2H₂O→H₂+Zn(OH)₂ (19)
Due to the rather modest reactivity of zinc in alkaline solution, the reaction requires the input of significant thermal energy in order to proceed at a reasonable rate. In fact, if this reaction is performed at room temperature, the observed reaction rate is virtually zero. In theory, the rate of this reaction could be enhanced by the inclusion of a colloidal metal catalyst. If colloidal silver in its ionic form, Ag_{c}⁺, is introduced, the colloidal silver ion will react efficiently with the zinc, due to the large effective surface area of the colloidal silver ion, and also perhaps due to the enhanced reactivity of zinc compared to silver, a result of the fact that zinc is above silver in the electromotive series. Thus, the colloidal silver ion will undergo reaction with zinc at an impressive rate according to equation 63.
2Ag_{c}⁺+Zn→Zn⁺²+2Ag_{c} (63)
The reduced silver, Ag_{c}, would be theorized to be present in a colloidal form and would thus undergo a facile reaction with water to produce elemental hydrogen and a base, as illustrated in equation 64.
2Ag_{c}+2H₂O→H₂+2Ag_{c}⁺+2OH⁻ (64)

Although the reaction represented by equation 64 would most likely be endothermic, it is believed that the exothermicity of the reaction shown in equation 63 compensates for this. Therefore, the combination of the two reactions yields a process that is thermally obtainable.

Consequently, elemental hydrogen is efficiently and easily produced by the combination of the reactions shown in equations 65 and 66.
2Zn+4Ag_{c}⁺→4Ag_{c}+2Zn⁺² (65)
4Ag_{c}+4H₂O→4Ag_{c}⁺+2H₂+4OH⁻ (66)

As shown, the solid zinc metal reacts with the colloidal silver ion in equation 65 to produce a product theorized to be elemental colloidal silver. It is believed the elemental colloidal silver will then react with water in equation 66 to produce elemental hydrogen and regenerate the colloidal-silver ion. The colloidal-silver ion will then react again by equation 65, followed again by equation 66, and so on in a chain reaction process to provide an efficient source of elemental hydrogen. Equations 65 and 66 can be combined, and this would result in the net reaction that is illustrated by equation 67. Equation 67 has as its result the production of elemental hydrogen from the reaction of zinc and water.
2Zn+4Ag_{c}⁺→4Ag_{c}+2Zn⁺² (65)
4Ag_{c}+4H₂O→4Ag_{c}⁺+2H₂+4OH⁻ (66)
=
2Zn+4H₂O→2Zn⁺²+2H₂+4OH⁻ (67)

Equation 67 summarizes a process that can provide an efficient production of elemental hydrogen where elemental zinc and water are consumed. It is believed, however, that the elemental zinc can be regenerated as a result of a voltaic electrochemical process and a thermal process that follows. Thus, colloidal magnesium ion Mg_{c}⁺² can undergo a voltaic oxidation-reduction reaction indicated by equations 68 and 60.
Cathode (reduction) 2Mg_{c}⁺+4e⁻→2Mg_{c} (68)
Anode (oxidation) 4OH⁻→2H₂O+O₂+4e⁻ (60)

It is believed that the resulting colloidal metal, Mg_{c}, may then react to regenerate the elemental zinc (equation 69).
2Zn⁺²+2Mg_{c}→2Mg_{c}⁺²+2Zn (69)

The reaction illustrated by equation 69 will take place quite efficiently due to the fact that magnesium is above zinc on the electromotive series of metals. Combining equations 68, 60, and 69 results in the reaction illustrated in equation 70, which represents the regeneration of the elemental zinc, and the formation of elemental oxygen.
2Mg_{c}⁺²+4e⁻→2Mg_{c} (68)
+
4OH⁻→2H₂O+O₂+4e⁻ (60)
+
2Zn⁺²+2Mg_{c}→2Mg_{c}⁺²+2Zn (69)
=
2Zn⁺²+4OH⁻→2H₂O+2Zn+O₂ (70)

Combining equations 67 and 70 results in a net process indicated in equation 34. Since equation 34 merely depicts the decomposition of water into elemental hydrogen and elemental oxygen, the complete process for the production of elemental hydrogen now has only water as an expendable substance.
2Zn+4H₂O→2Zn⁺²+2H₂+4OH⁻ (67)
+
2Zn⁺²+4OH⁻→2H₂O+2Zn+O₂ (70)
=
2H₂O→2H₂+O₂ (34)

The net result of this process is exactly that which would result from the electrolysis of water. Here, however, no electrical energy needs to be supplied. It is believed that the colloidal metallic ion catalysts as well as the elemental zinc are regenerated during the process; since the base is not consumed, water is the only material consumed.

While the net process illustrated by equation 67 is catalyzed by colloidal silver ion in an alkaline solution, the reaction rate is still found to be extremely slow at ambient temperatures presumably due to the low reactivity of zinc in the absence of additional thermal energy. The reaction rate can be significantly enhanced by the introduction of a second material that is inert but highly conductive, such as, but not limited to, tungsten carbide, which will be employed for this discussion. For this rate enhancement to be observable, the tungsten carbide must be conductively connected to the metallic zinc. The required connection can be achieved by having the two materials directly in contact, or they can be connected by a conductive medium, preferably made of a material low in reactivity such as copper. Under these conditions, the reaction represented by equation 65 is followed by an electrochemical voltaic process transpiring as illustrated in equations 71 and 60. The oxidation reaction represented by equation 71 takes place at the surface of the zinc electrode and the reduction reaction represented by equation 60 occurs at the surface of the tungsten carbide electrode.
2Zn+4Ag_{c}⁺→4Ag_{c}+2Zn⁺² (65)
Oxidation−4Ag_{c}→4Ag_{c}⁺+4e⁻ (71)
Reduction−4H₂O+4e⁻→2H₂+4OH⁻ (60)

When equations 71 and 60 are combined, the result is a voltaic oxidation-reduction reaction that is represented by equation 66.
Oxidation−4Ag_{c}→4Ag_{c}⁺+4e⁻ (71)
+
Reduction−4H₂O+4e⁻→2H₂+4OH⁻ (60)
=
4Ag_{c}+4H₂O−4Ag_{c}⁺+2H₂+4OH⁻ (66)

Thus, the net reaction illustrated by equation 66 has two significant applications that can be employed individually or simultaneously. Equation 66 results in the generation of elemental hydrogen; however equation 66 also produces a measurable electrical potential that will produce a potentially useful electrical current. Therefore the chemical system described here can provide a voltaic cell that produces energy. Concurrently, there is the production of hydrogen gas which can be used to provide additional energy when employed in a hydrogen cell or engine.

The favorable potential produced by equation 66 allows the entire process to proceed without the requirement of an outside energy source. It is the favorable energetics of equation 66 that provide the driving force for the entire process. If the connection between the zinc electrode and the tungsten carbide electrode is broken, however, the reaction of equation 66 will not occur, resulting in a decrease or a virtual cessation in the rate of production of hydrogen. Thus one can generate hydrogen gas in a completely controllable manner simply by completing and disconnecting the circuit created by connecting the tungsten carbide and zinc electrodes.

Combining equations 65, 71 and 60 again yields a net reaction that is illustrated by equation 67 as shown below.
2Zn+4Ag_{c}⁺→4Ag_{c}+2Zn⁺² (65)
+
4Ag_{c}→4Ag_{c}⁺+4e⁻ (71)
+
4H₂O+4e⁻→2H₂+4OH⁻ (60)
=
2Zn+4H₂O→2Zn⁺²+2H₂+4OH⁻ (67)
With the inclusion of the tungsten carbide electrode however, the net reaction shown by equation 67 will now progress at a significantly enhanced rate. It has been found that the generation of elemental hydrogen takes place at a considerable rate even at usual ambient temperatures.
Cathode Surface Area

Since the rate of hydrogen production is at least partially dependent upon the surface area of the cathode, the reaction rate can be further enhanced using any means that increases the surface area of the cathode. In fact, it has been shown that if the cathode is present as a thin foil or as a mesh in order to increase its surface area, there is an increase in the rate of hydrogen formation. Alternatively, it has been shown that the use of multiple cathodes, each in electrical contact with the metallic zinc anode, produces an increase in the rate of hydrogen production presumably resulting from the increase in the surface area of the cathode. The combination of these two effects results in an large surface area of the cathode, and a corresponding increase in the rate of hydrogen produced.

Regeneration of Metal

Although elemental zinc is consumed (equation 67), it is believed the zinc can be regenerated as a result of a voltaic electrochemical process and a subsequent thermal process similar to that shown for the regeneration of elemental metal, Mₛ, in equation 61. Thus, colloidal magnesium ion, Mg_{c}⁺², can take part in a voltaic oxidation-reduction reaction indicated by equations 68 and 60.
Cathode (reduction)−2Mg_{c}⁺²+4e⁻→2Mg_{c} (68)
Anode (oxidation)−4OH⁻→2H₂O+O₂+4e⁻ (60)

The resulting colloidal magnesium, Mg_{c}, will then react to reproduce elemental zinc (equation 69).
2Mg_{c}+2Zn⁺²→2Mg_{c}⁺²+2Zn (69)
Combining equations 68, 60, and 69 yields a reaction illustrated by equation 70 which represents the regeneration of the elemental zinc, and the formation of elemental oxygen.
2Mg_{c}⁺²+4e⁻→2Mg_{c} (68)
+
4OH⁻→2H₂O+O₂+4e⁻ (60)
+
2Mg_{c}+2Zn⁺²→2Mg_{c}⁺²+2Zn (69)
=
2Zn⁺²+4OH⁻→2H₂O+2Zn+O₂ (70)

Combining equations 67 and 70 results in equation 34. Since equation 34 merely depicts the decomposition of water into elemental hydrogen and elemental oxygen, the complete process for the production of elemental hydrogen now has only water as an expendable substance.
2Zn+4H₂O→2Zn⁺²+2H₂+4OH⁻ (67)
+
2Zn⁺²+4OH⁻→2H₂O+2Zn+O₂ (70)
=
2H₂O→2H₂+O₂ (34)

The net result of this process is exactly that which would result from the electrolysis of water, but no electrical energy needs to be supplied. It is believed that the colloidal metallic ion catalysts as well as the zinc metal are regenerated during the process, leaving water as the only consumable material. Since the net process shown by reaction 34 is dependent upon the electrical connection of the electrodes, the production of elemental hydrogen can be interrupted and resumed simply by breaking and reforming the electrical contact through a switch that connects and disconnects the two electrodes through a conductive inert wire.

Thus in the process depicted by the net equation 67 elemental hydrogen is produced along with the concurrent oxidation of elemental zinc to zinc ion. In the process portrayed by the net equation 70, the zinc ion is reduced to elemental zinc with the concurrent formation of elemental oxygen. As stated above, the theoretical net result of equations 67 and 70 is equation 34. It has been found, however, that the net reaction represented by equation 70 does not occur at a rate competitive with the net reaction depicted in equation 67. Thus under normal circumstances, the production of hydrogen is believed to take place at a rate significantly greater than the production of oxygen. In addition, the zinc metal will undergo oxidation more quickly than the zinc ion undergoes reduction so therefore the zinc electrode will eventually become depleted. It is clear, then, that the rate of the process will eventually slow to a point where the production of hydrogen will no longer proceed at a useful rate.

It has been found however that the reduction of zinc ion to yield elemental zinc can be achieved through an electrolytic process. Thus, a potential can be applied in the direction opposite to the normal flow of electrons to produce a different oxidation-reduction process. As outlined in experiments 15 and 16, the application of an external electrical potential causes the oxidation reaction of equation 60 and the reduction reaction of equation 72 to occur.
Oxidation−4OH⁻→2H₂O+O₂+4e⁻ (60)
Reduction−2Zn⁺²+4e−2Zn (72)
The addition of equation 60 and equation 72 once again results in equation 70, where the elemental zinc is regenerated on the electrode with the simultaneous production of elemental oxygen.
4OH⁻→2H₂O+O₂+4e⁻ (60)
+
2Zn⁺²+4e⁻→2Zn (72)
=
2Zn⁺²+4OH⁻→2H₂O+2Zn+O₂ (70)
From the standard oxidation and reduction potentials shown below, it is clear that the reactions represented by equations 60 and 72 will not take place spontaneously, having a standard cell potential of −1.136 volts.
4OH⁻→2H₂O+O₂+4e⁻ε⁰oxidation=−0.401 V
2Zn⁺²+4e⁻→2Znε⁰reduction=−0.762 V
The application of an external electrical potential will however cause this process to easily occur. Thus, when the production of hydrogen slows to an unacceptable rate, the process may be reversed by electrolysis, and the resulting rate of hydrogen formation will increase to that observed at the beginning of the process. Alternatively, the anode may simply be replaced.

In the preceding discussion, the colloidal metal ion catalysts, M_{f} and Mᵣ, are supplied along with the reactants as described in experiments 11 through 16. However, it has been found that the process can still proceed even without supplying colloidal metal catalysts as described in experiment 17. Although the reaction rate is decreased by a factor of approximately one-half, the production of elemental hydrogen is visibly obvious, and the voltaic potential produced is about the same as in the catalyzed reaction. The fact that the reaction can proceed with the apparent lack of catalysis is explained by the fact that metallic zinc and many other metals react very slowly with water in neutral or basic solutions to produce cations, such as the Zn⁺² ion, in very low concentration, as illustrated in equation 73.
Zn+2H₂O→H₂+Zn⁺²+2OH⁻ (73)

The cations produced in equation 73 will take part in the reaction in the same manner as the colloidal ions; however, they would catalyze the process with a limited efficiency compared to the colloidal catalysts. Thus when the catalysts are not physically added to the reaction mixture, it is still the catalyzed process discussed previously that occurs.

Controllable Reactions at an Enhanced Rate in Acidic Media

The rate of hydrogen production can also be increased by using as the anode a metal of higher reactivity, such as aluminum, and as the cathode a material that is inert but highly conductive, such as tungsten carbide, in a highly acidic solution that contains one or more dissolved acids, such as, but not limited to, sulfuric acid or hydrochloric acid. Additionally, there are preferably one or more salts or metal oxides (where, in acidic media, a metal oxide is the precursor to a salt) dissolved in the acidic solution, where each salt or metal oxide contains a cation of intermediate reactivity. For example, the salts or metal oxides may be, but are not limited to, zinc sulfide, zinc chloride, cobalt(II) sulfate, cobalt(II) chloride, zinc oxide, or cobalt(II) oxide. The solution preferably also contains one or more colloidal-metal ions.

While there are numerous ways in which this process may be performed, for the purposes of illustration, the process will be described where the reaction medium is a solution of sulfuric acid that contains colloidal silver ion, colloidal magnesium ion and zinc sulfate. Aluminum will be discussed as the metal of high reactivity, and tungsten carbide will be employed as the highly conductive, inert material.

At low values of pH, aluminum is known to produce hydrogen at a significant rate by reaction with sulfuric acid as illustrated by equation 74.
4Al+12H⁺+6SO₄⁻²→4Al⁺³+6H₂+6SO₄⁻² (74)

The rate of this reaction is in fact so impressive that the reaction of aluminum and sulfuric acid is often described as being uncontrollable. The rate of this reaction can be even further enhanced by the inclusion of colloidal silver ion, Ag_{c}⁺, which is believed to catalyze the reaction. Thus, aluminum will react with the colloidal silver ion in a reaction represented by equation 75. The metallic silver, Ag_{c}, that results is presumed to be in a colloidal state and is expected to react with sulfuric acid to produce elemental hydrogen by the reaction described by equation 76. Due to the colloidal nature of the silver, this reaction occurs at an even greater rate than the reaction of aluminum and sulfuric acid represented by equation 74.
4Al+12Ag_{c}⁺→4Al⁺³+12Ag_{c} (75)
12Ag_{c}+12H⁺+6SO₄⁻²→12Ag_{c}⁺+6H₂+6SO₄⁻² (76)

Combining equations 75 and 76 results in the net equation 74. However, the rate of hydrogen production will be enhanced by the presence of the colloidal silver.
4Al+12Ag_{c}⁺→4Al+12Ag_{c} (75)
+
12Ag_{c}+12H⁺+6SO₄⁻²→12Ag_{c}⁺+6H₂+6SO₄⁻² (76)
=
4Al+12H⁺+6SO₄⁻²→4Al⁺³+6H₂+6SO₄⁻² (74)

Equation 74 summarizes a process that can provide an extremely efficient production of elemental hydrogen where elemental aluminum and sulfuric acid are consumed. It is believed, however, that the elemental aluminum and the sulfuric acid can both be regenerated as a result of a voltaic electrochemical process and a thermal process described below:

Colloidal magnesium ion Mg_{c}⁺² can undergo a voltaic oxidation-reduction reaction indicated by equations 77 and 78.
Cathode (reduction) 6Mg_{c}⁺²+12e⁻→6Mg_{c} (77)
Anode (oxidation) 6H₂O→12H⁺+3O₂+12e⁻ (78)

It is believed that the resulting colloidal metal, Mg_{c}, may then react to regenerate the elemental aluminum (equation 79).
4Al⁺³+6SO₄−²+6Mg_{c}→6Mg_{c}⁺²+4Al+6SO₄−² (79)

The reaction illustrated by equation 79 will take place quite efficiently due to the fact that magnesium is above aluminum on the electromotive series of metals. Combining equations 77, 78 and 79 results in the reaction illustrated in equation 80, which represents the regeneration of the elemental aluminum, the regeneration of the sulfuric acid, and the formation of elemental oxygen.
6Mg_{c}⁺²+12e⁻→6Mg_{c} (77)
+
6H₂O→12H⁺+3O₂+12e⁻ (78)
+
4Al⁺³+6SO₄−²+6Mg_{c}→6Mg_{c}⁺²+4Al+6SO₄−² (79)
=
4Al^{°3}+6SO₄−²+6H₂O→12H⁺+6SO₄−²+4Al+3O₂ (80)

Combining equations 74 and 80 results in a net process indicated in equation 81. Since equation 81 merely depicts the decomposition of water into elemental hydrogen and elemental oxygen, the complete process for the production of elemental hydrogen now has only water as an expendable starting material.
4Al+12H⁺+6SO₄⁻²→4Al⁺³+6H₂+6SO₄⁻² (74)
+
4Al⁺³+6SO₄−²+6H₂O→12H⁺+6SO₄−²+4Al+3O₂ (80)
=
6H₂O→6H₂+3O₂ (81)

The net result of this process is exactly that which would result from the electrolysis of water. Here, however, no electrical energy needs to be supplied. It is believed that the colloidal metallic ion catalysts as well as the elemental aluminum are regenerated during the process; since the acid is not consumed, water is the only material consumed.

It has been found that the reaction illustrated by equation 74, whether catalyzed or uncatalyzed, can be inhibited by the dissolving of zinc sulfate into the sulfuric acid solution. In the absence of the colloidal silver catalyst, the elemental aluminum is thought to react with the zinc cation, thus replacing the reaction illustrated by equation 74 with the reaction depicted by equation 82. While the reaction of aluminum and zinc cation occurs preferentially to the reaction of aluminum and sulfuric acid, it has been found that the reaction proceeds at a rather low rate and, therefore, the aluminum is not appreciably consumed.
4Al+6Zn⁺²→4Al⁺³+6Zn (82)

With the inclusion of the colloidal silver cation, the reaction illustrated in equation 76 is replaced by the reaction shown in equation 83. Once again, while the reaction of colloidal silver and zinc cation occurs preferentially to the reaction of colloidal silver and sulfuric acid, it has been found that the reaction proceeds at a rather low rate. Thus, combining equations 75 and 84 results in the net equation 85. The reaction illustrated in equation 85 results in the consumption of aluminum; however, it is found to proceed at a rather low rate, and, thus, will not result in a large consumption of aluminum. The reaction shown in equation 85 will still, however, take place preferentially when in competition with the net reaction that is depicted in equation 74.
4Al+12Ag_{c}⁺→4Al^{°3}+12Ag_{c} (75)
+
12Ag_{c}+6Zn⁺²+6SO₄−²→12Ag_{c}⁺+6SO₄−²+6Zn (84)
=
4Al+6Zn⁺²→4Al⁺³+6Zn(net) (85)

Thus, the effect of the introduction of zinc chloride would be to severely limit or completely terminate the production of hydrogen from the net oxidation of aluminum. It has been found, however, that the rate of hydrogen formation can be increased to the point where it competes successfully with the net reaction depicted in equation 85. Specifically, the reaction rate for hydrogen production can be significantly enhanced by the introduction of a second material that is inert but highly conductive, such as, but not limited to, tungsten carbide, which will be employed for this discussion. Alternatively, in place of tungsten carbide, significant rate enhancement has also been achieved using nickel which has been melted with an acetylene torch with a carbonizing flame and then re-solidified. For this rate enhancement to be observable, the tungsten carbide must be conductively connected to the metallic aluminum. The required connection can be achieved by having the two materials directly in contact, or they can be attached by a conductive medium, preferably made of a material low in reactivity such as copper. Under these conditions, the reaction represented by equation 75 is followed by an electrochemical voltaic process transpiring as illustrated in equations 86 and 87. The oxidation reaction represented by equation 86 is believed to take place at the surface of the aluminum electrode and the reduction reaction represented by equation 87 is believed to occur at the surface of the tungsten carbide electrode.
4Al+12Ag_{c}⁺→4Al⁺³+12Ag_{c} (75)
Oxidation−12Ag_{c}→12Ag_{c}⁺+12e⁻ (86)
Reduction−12H⁺+12e⁻→6H₂ (87)

When equations 86 and 87 are combined, the result is a voltaic oxidation-reduction reaction that is represented by equation 88.
12Ag_{c}→12Ag_{c}⁺+12e⁻ (86)
+
12H⁺+12e→6H₂ (87)
=
12Ag_{c}+12H⁺→12Ag_{c}⁺¹+6H₂ (88)

Thus, the net reaction illustrated by equation 88 has two significant applications that can be employed individually or simultaneously. Equation 88 results in the generation of elemental hydrogen. Additionally, equation 88 produces a measurable electrical potential that could produce a potentially useful electrical current. Therefore, the chemical system described here can provide a voltaic cell that produces useful electrical energy. Concurrently, there is the production of hydrogen gas, which can be used to provide additional energy when employed in a hydrogen cell or an engine. The favorable potential produced by equation 88 is believed to allow the entire process to proceed without the requirement of an outside energy source. It is the favorable energetics of equation 88 that is believed provides the driving force for the entire process. If the connection between the aluminum electrode and the tungsten carbide electrode is broken, however, the reaction of equation 88 will not occur, resulting in a decrease or a virtual cessation in the rate of production of hydrogen. Thus, one can generate hydrogen gas in a controllable manner simply by completing and disconnecting the circuit created by connecting the tungsten carbide and aluminum electrodes.

Combining equations 75, 86 and 87 again yields a net reaction that is illustrated by equation 89 as shown below.
4Al+12Ag_{c}⁺→4Al⁺³+12Ag_{c} (75)
+
12Ag_{c}→12Ag_{c}⁺+12e⁻ (86)
+
12H⁺+12e⁻→6H₂ (87)
=
4Al+12H⁺→4Al⁺³+6H₂ (89)
The reaction that is represented by equation 89 occurs at an impressive reaction rate due to the high reactivity of aluminum. With the inclusion of the tungsten carbide electrode, however, the net reaction shown by equation 89 will now progress at an even faster rate. It is believed that this is due at least in part to the increased surface area of the tungsten carbide compared to that of the colloidal elemental silver. It has been found that the generation of elemental hydrogen takes place at a considerable rate even at usual ambient temperatures.

Since the rate of hydrogen production is believed to be at least partially dependent upon the surface area of the tungsten carbide cathode, the reaction rate can be further enhanced using any means that increases the surface area of the cathode. In fact, it has been shown that if the cathode is present as a thin foil or as a mesh in order to increase its surface area, there is an increase in the rate of hydrogen formation. Alternatively, it has been shown that the use of multiple cathodes, each in electrical contact with the metallic aluminum anode, produces an increase in the rate of hydrogen production, presumably resulting from the increase in the surface area of the cathode. The combination of these two effects, that is, the use of multiple cathodes consisting of a tungsten carbide mesh or foil, results in a large surface area of the cathode and a corresponding increase in the rate of hydrogen produced.

Employing the chemistry described above, a controllable production of hydrogen at an extremely high rate can be achieved.

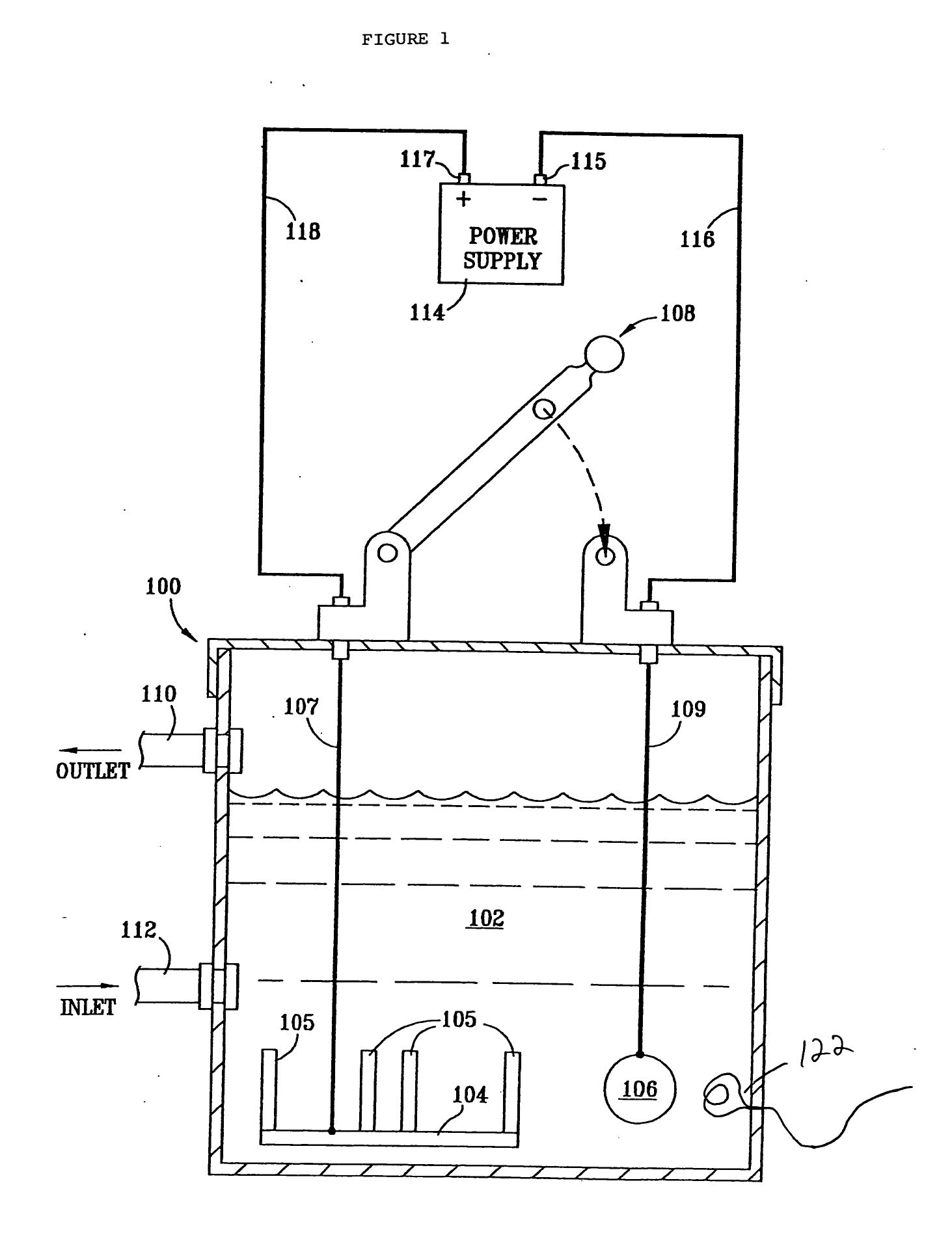

FIG. 1 shows a mixture and apparatus that may be used for the production of hydrogen. A reaction vessel 100 contains a reaction medium 102. The reaction medium preferably comprises water and, most preferably, further comprises either a base or an acid, although the reaction can exist at virtually any level of pH. Alternatively, it is believed that other reaction media may be used, including other solvents, or non-liquid media, such as gelatinous or gaseous media. In basic media, the base is preferably sodium hydroxide with a concentration of about 2.5 Molar, although other bases and other concentrations may be used. In acidic media, the acid is preferably sulfuric acid or hydrochloric acid with a pH of about 1.0, although other acids and other concentrations may be used. The reaction vessel 100 is preferably inert to the reaction medium 102.

The reaction medium 102 preferably contains a first colloidal metal (not shown) suspended in the solution. Although some of the reactions described above may proceed without a colloidal metal in the reaction medium 102, the colloidal metal significantly enhances the reaction rate. The first colloidal metal is preferably a metal with low activity, such as silver, gold, platinum, tin, lead, copper, zinc, or cadmium, although other metals may be used. Alternatively, as discussed above, other high-surface-area catalysts may be used in place of the colloidal metal.

Preferably, there is at least one cathode 104 in contact with the reaction medium 102. The cathode 104 may be in any form, but is preferably in the form of a solid with a relatively large surface area. Most preferably, the cathode 104 comprises a plurality of surface-area-enhancing features 105, which increase the surface area of the cathode. The surface-area-enhancing features 105 are preferably arranged to allow the reaction medium 102 or its constituents to move between them and to allow bubbles of produced gas to easily escape from the surface of the cathode 104. The surface-area-enhancing features 105 are preferably vertically-oriented rods projecting upwardly from a base of the cathode 104. However, the surface-area-enhancing features may be any feature, in electrical contact with the cathode 104, which effectively increases the surface area of the cathode 104. Alternatively, the cathode 104 may be in another relatively high-surface-area form, such as a coil, film, wool, nanomaterial, nanocoating, or the like. Further alternatively, a plurality of cathodes 104 may be used which combine to provide a larger surface area. The total surface area of the cathode(s) 104 is preferably greater than the surface area of the anode.

The cathode 104 preferably comprises a material that is highly conductive but virtually inert to the reaction medium 102, such as nickel, carbonized nickel, tungsten, or tungsten carbide. The cathode 104 most preferably comprises tungsten carbide.

The reaction vessel 100 also preferably comprises an anode 106 in contact with the reaction medium. The anode 106 preferably comprises a metal of high-range activity, and thus of a higher activity than the cathode. Most preferably, the anode 106 comprises aluminum, or a mixture of aluminum and other, less reactive, metals.

Preferably, the reaction medium 102 also contains a second colloidal metal (not shown). The second colloidal metal preferably has a higher activity than the metals comprising the cathode 104 and the anode 106, such as aluminum, magnesium, beryllium, and lithium. Alternatively, as discussed above, other high-surface-area catalysts may be used in place of the second colloidal metal.

Preferably, the reaction medium 102 also contains an ionic salt (not shown) comprising a metal cation that is less reactive than the metal composing the anode 106, and an anion that is largely inert to other constituents in the reaction medium, such as, but not limited to, zinc sulfate, zinc chloride, cobalt(II) sulfate, and cobalt(II) chloride.

The cathode 104 and the anode 106 are preferably conductively connected through conductive paths 107 and 109, respectively, to a controller 108 which may be manipulated to allow or restrict the flow of electricity between the cathode 104 and the anode 106. The controller 108 may be a switch, a variable resistor, or other device for allowing or resisting electric currents. When electrical current flows freely between the cathode 104 and the anode 106, it is found that the production of hydrogen will be maximized. When the conductive contact between the cathode 104 and the anode 106 is broken, hydrogen production will be minimal or zero. It is believed that a variable resistor between the anode 106 and the cathode 104 would allow a user to select from a wide range of hydrogen production rates.

The electrical energy produced by the reaction, which flows from the anode 104 to the cathode 106 through the conductive paths 107 and 109 may be used to provide electrical energy for a similar reaction occurring in a similar apparatus, or the system may be used as a battery, and the electrical energy created by the reaction can be used for other purposes. Alternatively, the cathode 104 and anode 105 may be placed in direct contact with one another.

The reaction vessel 100 preferably comprises an outlet 110 to allow hydrogen gas (not shown) and/or other products to escape. The reaction vessel may also have an inlet 112 for adding water or other constituents to maintain desired concentrations.

In addition, an electrical power source 114 may be used to intermittedly provide an electrical current through the reaction medium 102. The electrical power source 114 may be a battery, power outlet, generator, transformer, or the like. The electrical power source 114 preferably provides DC electrical power at a potential of at least 12 volts. A first terminal 115 of the electrical power source 114 is electrically connected through conductive paths 116 and 109 to the anode 106. A second terminal 117 of the electrical power source 114 is electrically connected through conductive paths 118 and 107 to the cathode 104. Preferably, the first terminal 115 has a higher electrical potential than the second terminal 117 so that when the controller 108 is configured in an open position (restricting current flow between the anode 106 and cathode 108), the electrical potential source 114 will cause a flow of electrical current in the opposite direction from when the controller 108 is closed and no external potential is applied. Power is applied from the electrical power soure 114 as needed to regenerate the anode and increase the hydrogen production rate. For most of the reaction duration, however, current is not applied. Alternatively, the anode 106 may be replaced by a new anode 106.

In addition, the apparatus preferably comprises an energy source 122. Although most of the reactions described above are believed to proceed without any energy input, hydrogen will be produced at a greater rate when additional energy is added. The energy source 122 shown in FIG. 1 is an electric heating coil, however, any form of thermal energy may be used including solar heating, combustion heating, hot plates, or the like. Generally, any energy source capable of heating the reaction medium above ambient temperatures may be used, and the particular source will preferably be chosen based on cost considerations. Additionally, it is believed that other energy types may be used, including, without limitation, electric energy, nuclear energy or electromagnetic radiation.

The hydrogen gas produced may be used in many known ways. Particularly, without limitation, the produced gas may be fed to a fuel cell to produce electric energy. Thus, the hydrogen production apparatus shown in FIG. 1 may be combined with a fuel cell (not shown) to form a compact and efficient source of electrical energy, which could be used to power a wide variety of devices.

Experimental Results:

Experiment #1 Summary:

An initial solution comprising 10 mL of 93% concentration H₂SO₄ and 30 mL of 35% concentration HCl was reacted with iron pellets (sponge iron) and about 50 mL of colloidal magnesium and 80 mL of colloidal lead, each at a concentration believed to be about 20 ppm. A theoretical maximum of 8.06 liters of hydrogen gas could be produced if solely from the consumption of the acids as indicated in Table 1.

TABLE 1
Starting Solution Maximum H₂ Yield with Acid Consumption

| | | | Total | Effective | Maximum H₂ |
|---|---|---|---|---|---|
| Acid | mL | Concentration | Grams | Grams of Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole H₂ (22.4 liters)

1 mole H₂SO₄=98 grams

Therefore, the maximum yield is 0.23 liters of H₂ per gram of H₂SO₄.

2 moles of HCl yields 1 mole H₂ (22.4 liters)

2 moles of HCl=73 grams

Therefore, a theoretical maximum yield of 0.31 liters of H₂ per gram of HCl is expected without the regeneration reaction.

At least 15 liters of gas was observed to have been produced, and the reaction was still proceeding in a continuous fashion (about 2 bubbles of gas per second at 71° C.) when interrupted. It should be noted that the 15 liters of gas observed does not account likely losses of hydrogen gas due to leakage. Based upon previous observations and theoretical projections, the first 8.06 liters of gas produced is likely to be made up of essentially pure hydrogen; beyond the theoretical threshold of 8.06 liters, 66.7% by volume of the gas produced would be hydrogen and the other 33.3% by volume would be oxygen. It is believed this experiment provides ample evidence of the regeneration process.

A follow-up experiment was conducted using iron (III) chloride (FeCl₃) as the only source of iron in an attempt to verify the reverse reaction. Pure iron (III) chloride was chosen because it could be shown to be free of iron in any other oxidation state. While similar experiments had been successfully carried out using iron (III) oxide as the source of iron, the results were clouded by the fact that other oxidation states of iron may have been present. The results are described in Experiment #2, below.

Experiment #2 Summary:

An experiment was conducted using 150 mL of iron (III) chloride in an aqueous solution (commonly used as an etching solution, purchased from Radio Shack) as the starting materials. Ten mL of 93% concentration sulfuric acid (H₂SO₄) was added to the solution, at which point no reaction occurred. About 50 mL of colloidal magnesium and 80 mL of colloidal lead, each at a concentration believed to be about 20 ppm, were then added, at which point a chemical reaction began and the bubbling of gases was evident at ambient temperature. The production of gas accelerated when the solution was heated to a temperature of 65° C. The product gas was captured in soap bubbles and the bubbles were then ignited. The observed ignition of the gaseous product was typical for a mixture of hydrogen and oxygen.

Since hydrogen gas could only be produced with a concurrent oxidation of iron, it is evident that the iron (III) had to be initially reduced before it could be oxidized, thereby providing strong evidence of the reverse reaction. This experiment has subsequently been repeated with hydrochloric acid (HCl) instead of sulfuric acid, with similar results.

Two additional follow-up experiments (#3 using aluminum metal and #4 using iron metal) were conducted to determine if more hydrogen is produced compared to the maximum amount expected solely from the consumption of the metal. These results are described below.

Experiment #3 Summary:

The starting solution had a total volume of 250 mL, including water, about 50 mL of colloidal magnesium and 80 mL of colloidal lead, each at a concentration believed to be about 20 ppm, 10 mL of 93% concentration H₂SO₄, and 30 mL of 35% concentration HCl as in experiment #1 above. Ten grams of aluminum metal was added to the solution, which was heated and maintained at 90° C. The reaction ran for 1.5 hours and yielded 12 liters of gas. The pH was found to have a value under 2.0 at the end of 1.5 hours. The reaction was stopped after 1.5 hours by removing the unused metal and weighing it. The non-consumed aluminum weighed 4.5 grams, indicating a consumption of 5.5 grams of aluminum. The maximum amount of hydrogen gas normally expected by the net consumption of 5.5 grams of aluminum is 6.8 liters, as indicated in the table below.

TABLE 2
Starting Solution Maximum H₂ Yield
With Aluminum Consumption

| | Total Grams | Total Grams | Grams | Maximum |
|---|---|---|---|---|
| Metal | Initial Supply | Final | Consumed | Yield* of H₂ |
| Aluminum | 10 | 4.5 | 5.5 | 6.84 liters |
| (Al) | | | | |

*If reacted aluminum has exclusively been used for the production of hydrogen:
2 moles Al yields 3 moles H₂ (67.2 liters)
2 moles Al = 54 grams

Therefore, a theoretical maximum yield of 1.24 liters of H₂ per gram of Al is expected without the regeneration reaction described above.

As in experiment #1, based on the total amount of acid supplied, it is expected that the first 8.06 liters of the gas generated is pure hydrogen with the balance being 50% hydrogen. Alternatively, the theoretical amount of hydrogen based on the amount of aluminum consumed is 6.84 liters. After 6.84 liters (the maximum yield expected from the aluminum consumed), it is expected that the remaining gas is 66.7% hydrogen. Therefore, it is estimated that about 10.3 liters of hydrogen (out of about 12 total liters of gas) was produced in this experiment, compared to the maximum of 6.84 or 8.06 liters expected, based on the amount of aluminum consumed and the amount of acid supplied, respectively, thereby providing additional evidence of the regeneration process.

Experiment #4 Summary:

The starting solution included a total volume of 250 mL, including water, about 50 mL of colloidal magnesium and 80 mL of colloidal lead, each at a concentration believed to be about 20 ppm, 10 mL of 93% concentration H₂SO₄ and 30 mL of 35% concentration HCl, as in experiment #1 above. One hundred grams of iron pellets (sponge iron) was added to the solution, which was heated and maintained at 90° C. The reaction ran for 30 hours and yielded 15 liters of gas. The pH was found to have a value of about 5.0 at the end of 30 hours. The reaction was stopped after 30 hours by removing the unused metal and weighing it. The non-consumed iron weighed 94 grams, indicating a consumption of 6 grams of iron. The maximum amount of hydrogen gas normally expected by the net consumption of 6 grams of iron, without the regeneration reaction described above, is 2.41 liters, as indicated in the table below.

TABLE 3
Starting Solution Maximum H₂ Yield With Iron Consumption

| | Total Grams | Total Grams | Grams | Maximum |
|---|---|---|---|---|
| Metal | Initial Supply | Final | Consumed | Yield* of H₂ |
| Iron (Fe) | 100 | 94 | 6 | 2.41 liters |

*If reacted iron has exclusively been used for the production of hydrogen:
1 mole Fe yields 1 mole H₂ (22.4 liters)
1 mole Fe = 55.85 grams

Therefore, a theoretical maximum yield of 0.40 liters of H₂ per gram of Fe is expected without the regeneration reaction described above.

As in experiment #1, based on the total amount of acid supplied, it is expected that the first 8.06 liters of the gas generated is pure hydrogen with the balance being 66.7% hydrogen. However, the maximum theoretical generation of hydrogen based on the amount of iron consumed is 2.41 liters. After 2.41 liters (the maximum yield expected from the iron consumed), it is expected that the remaining gas is 66.7% hydrogen. Therefore, it is estimated that about 10.8 liters of hydrogen (out of about 15 total liters of gas) was produced in this experiment using colloidal catalyst, well over the maximum of 2.41 liters expected with the amount of iron consumed, thereby providing additional evidence of the regeneration process.

Experiment #5 Summary:

An experiment was conducted using 200 mL of the final solution obtained from experiment #4, which contained oxidized iron plus catalyst and was found to have a pH of about 5. Acid was added to the solution, as in the above reactions, i.e., 10 mL of 93% concentration H₂SO₄ and 30 mL of 35% concentration HCl that brought the pH to a level of about 1. No additional colloidal materials were added, but 20 grams of aluminum metal was added. The solution was maintained at a constant temperature of 96° C. The reaction proceeded to produce 32 liters of gas in a span of 18 hours, at which point the rate of the reaction had slowed significantly and the pH of the solution had become approximately 5.

The metal remaining at the end of the 18-hour experiment was separated and found to have a mass of 9 grams. This metal appeared to be a mixture of Al and Fe. Therefore, neglecting the amount of iron and aluminum remaining in solution, there was net consumption of 11 grams of metal and a net production of 32 liters of gas.

As indicated above, based on the amount of acid added to the reaction, the maximum amount of hydrogen gas expected solely from the reaction of acid with metal would be 8.06 liters. Depending on the makeup of the recovered metal, which had a mass of 9 grams, two extremes are possible: a) assuming the metal recovered was 100% Al, a maximum of 13.75 liters of hydrogen gas would be expected from the consumption of 11 grams of aluminum; and b) alternatively, assuming the metal recovered was 100% Fe, a maximum of 21.25 liters of hydrogen gas would be expected from the consumption of 17 grams of aluminum (20 grams supplied minus three grams used in the production of iron). For purposes of calculating maximum hydrogen gas generation, we assume the regeneration process does not occur and the Fe metal would have been generated from a conventional single displacement reaction with Al.

The actual percentage of Al and Fe would be somewhere between the two extremes and, therefore, the maximum amount of hydrogen gas generated solely from the consumption of metal (without regeneration) would be between 13.75 liters and 21.25 liters. The observed generation of 32 liters of gas compared to the maximum amount one would expect from the sole consumption of metal indicates that the regeneration process is taking place. It is believed that the increase in the rate of H₂ production resulted from a high concentration of metal ions in the solution prior to the introduction of the elemental iron. Thus, solutions resulting from this family of reactions should not be discarded but rather should be used as the starting point for subsequent reactions. Consequently, this process for the generation of H₂ will not produce significant chemical wastes that require disposal.

Experiment #6 Summary:

An experiment was conducted using 20 mL FeCl₃, 10 mL colloidal magnesium, and 20 mL colloidal lead at a temperature of about 90° C. A gas was produced that is believed to be a mixture of hydrogen and oxygen, based upon observing the ignition of the gas. The pH of the mixture decreased during the reaction from a value of about 4.5 to a value of about 3.5. These observations show that it is not necessary to introduce either metallic iron or acid into the solution to produce hydrogen. Since the electrochemical oxidation/reduction reactions (equations 30-32 resulting in the net equation 33) result in the production of metallic iron and acid, these two constituents can be produced in this manner. Presumably, this would eventually attain the same steady state that is reached when metallic iron and acid are supplied initially.

Experiment #7 Summary

An initial solution comprising 10 mL of 93% concentration H₂SO₄ and 30 mL of 35% concentration HCl was reacted with 20 grams of iron pellets and 20 grams of aluminum pellets. There were then added 50 mL of colloidal magnesium and 80 mL of colloidal lead, each at a concentration believed to be about 20 ppm, producing a total volume of about 215 mL. A theoretical maximum of 8.06 liters of hydrogen gas could be produced if solely from the consumption of the acids as indicated in Table 4.

TABLE 4
Starting Solution Maximum H₂ Yield with Acid Consumption

| | | | Total | Effective | Maximum H₂ |
|---|---|---|---|---|---|
| Acid | mL | Concentration | Grams | Grams of Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole of H₂ (22.4 liters @ STP)

1 mole H₂SO₄=98 grams

Therefore, a theoretical maximum yield of 0.23 liters of H₂ per gram of H₂SO₄ is expected without the regeneration reaction.

2 moles of HCl yields 1 mole of H₂ (22.4 liters @ STP)

2 moles of HCl=73 grams

Therefore, a theoretical maximum yield of 0.31 liters of H₂ per gram of HCl is expected without the regeneration reaction.

While some gas was lost due to leakage and diffusion, at least 25 liters of gas was collected over a period of three hours, and the reaction was still proceeding in a continuous fashion at a rate of 8.4 liters of gas produced per hour. At this point the reaction was stopped and the remaining metal, a mixture of aluminum and iron was collected and dried, and was found to have a mass of 35.5 grams. Thus, 4.5 grams of metal was consumed. Since the remaining metal was not analyzed, it is not known in what ratio aluminum and iron reacted; however the simple oxidation of a metal by an acid would produce a maximum of 5.6 liters of hydrogen, well below that observed. Based upon previous observations and theoretical projections, the first 8.06 liters of gas produced is likely to be made up of essentially pure hydrogen, and beyond the theoretical threshold of 8.06 liters, 66.7% by volume of the gas produced would be hydrogen and the other 33.3% by volume would be oxygen. It is believed this experiment provides ample evidence for the regeneration process.

It is believed that the simultaneous use of two metals does not improve the initial rate of gas formation, but rather produces a reaction whose rate is sustained over a much greater period of time. In order to demonstrate this point, two additional experiments were performed.

Experiment #8 Summary:

An initial solution comprising 10 mL of 93% concentration H₂SO₄ and 30 mL of 35% concentration HCl was reacted with 20 grams of aluminum pellets. There were then added 50 mL of colloidal magnesium and 80 mL of colloidal lead each at a concentration believed to be about 20 ppm, producing a total volume of about 215 mL. A theoretical maximum of 8.06 liters of hydrogen gas could be produced if solely from the consumption of the acids as indicated in Table 5.

TABLE 5
Starting Solution Maximum H₂ Yield with Acid Consumption

| | | | Total | Effective | Maximum H₂ |
|---|---|---|---|---|---|
| Acid | mL | Concentration | Grams | Grams of Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

GRIF

1 mole H₂SO₄ yields 1 mole of H₂ (22.4 liters @ STP)

1 mole H₂SO₄=98 grams

Therefore, a theoretical maximum yield of 0.23 liters of H₂ per gram of H₂SO₄ is expected without the regeneration reaction.

2 moles of HCl yields 1 mole of H₂ (22.4 liters @ STP)

2 moles of HCl=73 grams

Therefore, a theoretical maximum yield of 0.31 liters of H₂ per gram of HCl is expected without the regeneration reaction.

The initial reaction rate was similar to that found in experiment #1, where 9 liters of gas was produced in slightly less than one hour. At this point, however, the reaction rate was found to decrease by a factor of approximately one-half. The addition of 20 grams of iron caused an immediate increase in reaction rate to the value that was initially observed at the onset of the experiment.

Experiment #9 Summary:

An initial solution comprising 10 mL of 93% concentration H₂SO₄ and 30 mL of 35% concentration HCl was reacted with 40 grams of aluminum pellets. There were then added 50 mL of colloidal magnesium and 80 mL of colloidal lead, each at a concentration believed to be about 20 ppm, producing a total volume of about 215 mL. A theoretical maximum of 8.06 liters of hydrogen gas could be produced if solely from the consumption of the acids as indicated in Table 6.

TABLE 6
Starting Solution Maximum H₂ Yield with Acid Consumption

| | | | Total | Effective | Maximum H₂ |
|---|---|---|---|---|---|
| Acid | mL | Concentration | Grams | Grams of Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole of H₂ (22.4 liters @ STP)

1 mole H₂SO₄=98 grams

Therefore, a theoretical maximum yield of 0.23 liters of H₂ per gram of H₂SO₄ is expected without the regeneration reaction.

2 moles of HCl yields 1 mole of H₂ (22.4 liters @ STP)

2 moles of HCl=73 grams

Therefore, a theoretical maximum yield of 0.31 liters of H₂ per gram of HCl is expected without the regeneration reaction.

The initial reaction rate was similar to that found in experiment #1, where 9 liters of gas was produced in slightly less than one hour. At this point, however, the reaction rate was found to decrease by a factor of approximately one-half. The addition of 20 grams of iron caused an immediate increase in reaction rate to the value that was observed at the onset of the experiment.

Clearly an interaction is taking place between the two metals that produces a reaction that sustains a high rate of gas production a significant period of time.

Experiment #10 Summary:

An initial solution comprising 10 mL of 93% concentration H₂SO₄ and 30 mL of 35% concentration HCl was reacted with 20 grams of iron pellets and 20 grams of aluminum pellets. There were then added 25 mL of colloidal magnesium and 40 mL of colloidal lead, each at a concentration believed to be about 20 ppm, producing a total volume of about 110 mL. A theoretical maximum of 8.06 liters of hydrogen gas could be produced if solely from the consumption of the acids as indicated in Table 7.

TABLE 7
Starting Solution Maximum H₂ Yield with Acid Consumption

| | | | Total | Effective | Maximum H₂ |
|---|---|---|---|---|---|
| Acid | mL | Concentration | Grams | Grams of Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole of H₂ (22.4 liters @ STP)

1 mole H₂SO₄=98 grams

Therefore, a theoretical maximum yield of 0.23 liters of H₂ per gram of H₂SO₄ is expected without the regeneration reaction.

2 moles of HCl yields 1 mole of H₂ (22.4 liters @ STP)

2 moles of HCl=73 grams

Therefore, a theoretical maximum yield of 0.31 liters of H₂ per gram of HCl is expected without the regeneration reaction.

The rate of the reaction initially is very fast with instantaneous hydrogen generation at a rate of about 20 liters per hour. After about an hour the rate slows to a steady-state value of about 6.0 liters per hour. Additional heat may be added to accelerate the process of regenerating the metals and the acids.

While some gas was lost due to leakage and diffusion, at least 32 liters of gas was collected over a period of five hours, and the reaction was still proceeding in a continuous fashion at a rate of 6.0 liters per hour. At this point, the reaction was stopped and the remaining metal, a mixture of aluminum and iron was collected and dried, and was found to have a mass of about 40 grams. Thus, only a negligible amount of metal was consumed. Since the remaining metal was not analyzed, it is not known in what ratio aluminum and iron were present; however, it can be assumed that approximately 20 grams of each metal was present in the remaining metallic sample. Based upon previous observations and theoretical projections, the first 8.06 liters of gas produced is likely to be made up of essentially pure hydrogen, and beyond the theoretical threshold of 8.06 liters, 66.7% by volume of the gas produced would be hydrogen and the other 33.3% by volume would be oxygen. It is believed this experiment provides further evidence for a more efficient regeneration process when smaller volumes are used in the reaction vessel.

Experiment #11 Summary:

An initial solution comprising 10 g of sodium hydroxide, 20 mL of colloidal silver, and 10 mL of colloidal magnesium, where each of the colloidal solutions had a concentration believed to be about 20 ppm was diluted with 70 mL of distilled water. There was then added to the solution 20 g of metallic zinc and 20 g of metallic nickel. Initially the two metals were not in contact and virtually no reaction and no gas evolution were observed. When the zinc and nickel metals were moved into contact with each other, a vigorous evolution of gas was observed emanating from the surface of the nickel metal. The gaseous product produced at the surface of the metallic nickel was captured in soap bubbles and was ignited. The explosion upon ignition strongly indicated the presence of elemental hydrogen in the product gas.

Experiment #12 Summary:

An initial solution comprising 10 g of sodium hydroxide, 20 mL of colloidal silver, and 10 mL of colloidal magnesium, where each colloidal solution had a concentration believed to be about 20 ppm, was diluted with 70 mL of distilled water. There was then added to the solution a small piece of metallic zinc and a small piece of metallic nickel each connected to a piece of copper wire approximately three inches long. A vigorous evolution of gas was observed emanating from the surface of the nickel metal. The gaseous product produced at the surface of the metallic nickel was captured in soap bubbles and was ignited. The explosion upon ignition strongly indicated the presence of elemental hydrogen in the product gas.

Experiment #13 Summary:

An initial solution comprising 10 g of sodium hydroxide, 20 mL of colloidal silver, and 10 mL of colloidal magnesium, where each colloidal solution had a concentration believed to be about 20 ppm, was diluted with 70 mL of distilled water. There was then added to the solution a small piece of metallic zinc, and a small piece of a tungsten carbide, each connected to a piece of copper wire that extended outside of the solution. When the ends of the copper wire were not in direct contact, virtually no reaction and no gas evolution were observed. When the two ends of the copper wire were placed into contact a vigorous evolution of gas was observed emanating from the surface of the tungsten carbide electrode. The gas evolution could be stopped and restarted repeatedly simply by removing and then replacing the connection at the two ends of the copper wires. When the two copper wires were not in contact, a potential of about 0.3 volts was measured across the two ends of the copper wires. The gaseous product produced at the surface of the tungsten carbide sample was captured in soap bubbles and was ignited. The explosion upon ignition strongly indicated the presence of elemental hydrogen in the product gas. After about 100 hours the rate of gas evolution and the measured potential were unchanged.

Experiment #14 Summary:

An initial solution comprising 9.8 g of sodium hydroxide, 20 mL of colloidal silver, and 10 mL of colloidal magnesium, where each colloidal solution had a concentration believed to be about 20 ppm, was diluted with 70 mL of distilled water. There was then added to the solution 42.2 g of tungsten carbide directly fused to 30.3 g of metallic zinc. A vigorous evolution of gas was observed emanating from the surface of the tungsten carbide electrode. After a period of two hours, approximately 1.5 L of gaseous product had been collected. The reaction was stopped at this point and the solution was found to have a pH of 11, and it was further determined that 2.8 g of metal had been consumed.

Experiment #15 Summary:

An initial solution comprising 10 g of sodium hydroxide, 20 mL of colloidal silver, and 10 mL of colloidal magnesium, where each colloidal solution had a concentration believed to be about 20 ppm, was diluted with 70 mL of distilled water. There was then added to the solution a small piece of metallic zinc and a small piece of a tungsten carbide, each connected to a piece of copper wire that extended outside of the solution. When the ends of the copper wire were not in direct contact, virtually no reaction and no gas evolution were observed. When the two ends of the copper wire placed into contact, a vigorous evolution of gas was observed emanating from the surface of the tungsten carbide electrode. The gas evolution could be stopped and restarted repeatedly simply by removing and then replacing the connection at the two ends of the copper wires. When the two copper wires were not in contact, a potential of about 0.3 volts was measured across the two ends of the copper wires. The gaseous product produced at the surface of the tungsten carbide sample was captured in soap bubbles and was ignited. The explosion upon ignition strongly indicated the presence of elemental hydrogen in the product gas. After about 100 hours the rate of gas evolution and the measured potential were unchanged. An external 12-volt power source was then attached to the electrodes in order to cause a flow of electrical current in the direction opposite to what had been observed. Upon the application of this potential the zinc metal was observed to reform on the electrode with the concurrent production of a gas thought to be elemental oxygen.

Experiment #16 Summary:

An initial solution comprising 10 g of sodium hydroxide, 20 mL of colloidal silver, and 10 mL of colloidal magnesium, where each colloidal solution had a concentration believed to be about 20 ppm, was diluted with 70 mL of distilled water. There was then added to the solution a small piece of metallic zinc and a small piece of a tungsten carbide, each connected to a piece of copper wire that extended outside of the solution. When the ends of the copper wire were not in direct contact, virtually no reaction and no gas evolution were observed. When the two ends of the copper wire placed into contact a vigorous evolution of gas was observed emanating from the surface of the tungsten carbide electrode. The gas evolution could be stopped and restarted repeatedly simply by removing and then replacing the connection at the two ends of the copper wires. When the two copper wires were not in contact a potential of about 0.3 volts was measured across the two ends of the copper wires. The gaseous product produced at the surface of the tungsten carbide sample was captured in soap bubbles and was ignited. The explosion upon ignition strongly indicated the presence of elemental hydrogen in the product gas. After about 100 hours the rate of gas evolution and the measured potential were unchanged. The zinc electrode was then removed and replaced by an electrode consisting of copper wire. There was no observable chemical reaction when the circuit was completed. An external 12-volt power source was then attached to the electrodes in order to cause a flow of electrical current in the direction opposite to what had been observed. Upon application of this potential the zinc metal was observed to reform on the copper electrode with the concurrent production of a gas thought to be elemental oxygen. After 10 minutes, the external 12-volt power source was disconnected and the circuit was once again completed by placing the two ends of copper wire into contact. When the two ends of the copper wire placed into contact, a vigorous evolution of gas was observed emanating from the surface of the tungsten carbide electrode, the rate of which was approximately equal to the rate that had been initially observed.

Experiment #17 Summary:

An initial solution was prepared by dissolving 10 g of sodium hydroxide in 100 mL of distilled water. There was then added to the solution a small piece of metallic zinc and a small piece of a tungsten carbide each connected to a piece of copper wire that extended outside of the solution. When the ends of the copper wire were not in direct contact, virtually no reaction and no gas evolution were observed. When the two ends of the copper wire were placed into contact, the evolution of gas was observed emanating from the surface of the tungsten carbide electrode. The rate of gas evolution was noticeably less than the rate observed with the inclusion of the colloidal catalysts. The gas evolution could be stopped and restarted repeatedly simply by removing and then replacing the connection at the two ends of the copper wires. When the two copper wires were not in contact, a potential of about 0.3 volts was measured across the two ends of the copper wires. The gaseous product produced at the surface of the tungsten carbide sample was captured in soap bubbles and was ignited. The explosion upon ignition strongly indicated the presence of elemental hydrogen in the product gas.

Experiment #18 Summary:

An initial solution comprising 10 g of sodium hydroxide, 20 mL of colloidal silver, and 10 mL of colloidal magnesium, where each colloidal solution had a concentration believed to be about 20 ppm, was diluted with 70 mL of distilled water. There was then added to the solution a small piece of metallic zinc, and a copper plate connected to four pieces of a tungsten carbide. The metallic zinc and the copper plate were each connected to a piece of copper wire that extended outside of the solution. When the ends of the copper wire were not in direct contact, virtually no reaction and no gas evolution were observed. When the two ends of the copper wire were placed into contact, a vigorous evolution of gas was observed emanating from the surface of each of the pieces of the tungsten carbide. The total rate of gas evolution was approximately four times that obtained when a single piece of tungsten carbide was employed, indicating the relationship between the rate of hydrogen production and the surface area of the cathode. The gas evolution could be stopped and restarted repeatedly simply by removing and then replacing the connection at the two ends of the copper wires. When the two copper wires were not in contact, a potential of about 0.3 volts was measured across the two ends of the copper wires. The gaseous product produced at the surface of the tungsten carbide sample was captured in soap bubbles and was ignited. The explosion upon ignition strongly indicated the presence of elemental hydrogen in the product gas.

Experiment #19 Summary:

An initial solution comprising 5 mL of 93% concentration H₂SO₄, 10 mL of 35% concentration HCl, 25 mL of colloidal silver, and 10 mL of colloidal magnesium, where each colloidal solution had a concentration believed to be about 20 ppm, was diluted with 50 mL of distilled water. There was then added to the solution a small piece of a metal alloy consisting of metallic tin and metallic lead and a small piece of a tungsten carbide, each connected to a piece of copper wire that extended outside of the solution. When the ends of the copper wire were not in direct contact, virtually no reaction and no gas evolution were observed. When the two ends of the copper wire were placed into contact, a rather evolution of gas was observed emanating from the surface of the tungsten carbide electrode. The gas evolution could be stopped and restarted repeatedly simply by removing and then replacing the connection at the two ends of the copper wires. The gaseous product produced at the surface of the tungsten carbide sample was captured in soap bubbles and was ignited. The explosion upon ignition strongly indicated the presence of elemental hydrogen in the product gas.

Experiment #20 Summary:

An initial solution comprising 5 mL of 93% concentration H₂SO₄, 10 mL of 35% concentration HCl, 25 mL of colloidal silver, and 10 mL of colloidal magnesium, where each colloidal solution had a concentration believed to be about 20 ppm, was diluted with 50 mL of distilled water. There was then added to the solution a small piece of a metal alloy consisting of metallic tin and metallic lead and a small piece of a tungsten carbide, each connected to a piece of copper wire that extended outside of the solution. When the ends of the copper wire were not in direct contact, virtually no reaction and no gas evolution were observed. When the two ends of the copper wire placed into contact, a vigorous evolution of gas was observed emanating from the surface of the tungsten carbide electrode. The gas evolution could be stopped and restarted repeatedly simply by removing and then replacing the connection at the two ends of the copper wires. The gaseous product produced at the surface of the tungsten carbide sample was captured in soap bubbles and was ignited. The explosion upon ignition strongly indicated the presence of elemental hydrogen in the product gas. After about 10 hours the rate of gas evolution was unchanged. The tin-lead electrode was then removed and replaced by an electrode consisting of copper wire. There was no observable chemical reaction when the circuit was completed. An external 12-volt power source was then attached to the electrodes in order to cause a flow of electrical current in the direction opposite to what had been observed. Upon the application of this potential a metal was observed to reform on the copper electrode, with the concurrent production of a gas thought to be elemental oxygen. After 10 minutes, the external 12-volt power source was disconnected and the circuit was once again completed by placing the two ends of copper wire into contact. When the two ends of the copper wire placed into contact, a vigorous evolution of gas was observed emanating from the surface of the tungsten carbide electrode, the rate of which was approximately equal to the rate that had been initially observed.

Experiment #21 Summary:

An initial solution comprising 5 mL of 93% concentration H₂SO₄, 10 mL of 35% concentration HCl, 25 mL of colloidal silver, and 10 mL of colloidal magnesium, where each colloidal solution had a concentration believed to be about 20 ppm, was diluted with 50 mL of distilled water. There was then added to the solution a small piece of a metal alloy consisting of metallic tin and metallic lead and a copper plate connected to four pieces of a tungsten carbide. The metallic tin-lead alloy and the copper plate were each connected to a piece of copper wire that extended outside of the solution. When the ends of the copper wire were not in direct contact, virtually no reaction and no gas evolution was observed. When the two ends of the copper wire were placed into contact, a vigorous evolution of gas was observed emanating from the surface of each of the pieces of the tungsten carbide. The total rate of gas evolution was approximately four times that obtained when a single piece of tungsten carbide was employed, indicating the relationship between the rate of hydrogen production and the surface area of the cathode. The gas evolution could be stopped and restarted repeatedly simply by removing and then replacing the connection at the two ends of the copper wires. When the two copper wires were not in contact, a potential of about 0.3 volts was measured across the two ends of the copper wires. The gaseous product produced at the surface of the tungsten carbide sample was captured in soap bubbles and was ignited. The explosion upon ignition strongly indicated the presence of elemental hydrogen in the product gas.

Experiment #22 Summary:

An initial solution comprising 8 mL of 93% concentration H₂SO₄, 24 mL of 35% concentration HCl, 20 mL of colloidal silver, and 20 mL of colloidal magnesium, where each colloidal solution had a concentration believed to be about 20 ppm, was diluted with 75 mL of distilled water. There was then added to the solution 10 g of zinc sulfate heptahydrate. To a 25 mL aliquot of this solution was added a small piece of aluminum mesh and a small piece of tungsten carbide, each connected to one of two copper wires that extended outside of the solution. When the ends of the copper wires were not in direct contact with each other, virtually no reaction and no gas evolution were observed. When the two ends of the copper wires were placed into contact, a very vigorous evolution of gas was observed emanating from the surface of the tungsten carbide electrode. The rate of hydrogen formation was comparable to that obtained by the uncatalyzed reaction of pure aluminum with mineral acid at a similar level of acidity. The gas evolution could be stopped and restarted repeatedly simply by removing and then replacing the connection between the copper wires. The gaseous product produced at the surface of the tungsten carbide sample was captured in soap bubbles and ignited. The explosion upon ignition strongly indicated the presence of elemental hydrogen in the product gas.

Experiment #23 Summary:

An initial solution comprising 8 mL of 93% concentration H₂SO₄, 24 mL of 35% concentration HCl, 20 mL of colloidal silver, and 20 mL of colloidal magnesium, where each colloidal solution had a concentration believed to be about 20 ppm, was diluted with 75 mL of distilled water. There was then added to the solution 10 g of cobalt (II) sulfate heptahydrate. To a 25 mL aliquot of this solution was added a small piece of aluminum mesh and a small piece of tungsten carbide, each connected to one of two copper wires that extended outside of the solution. When the ends of the copper wires were not in direct contact, virtually no reaction and no gas evolution were observed. When the two ends of the copper wires were placed into contact, a very vigorous evolution of gas was observed emanating from the surface of the tungsten carbide electrode. The rate of hydrogen formation was comparable to that obtained by the uncatalyzed reaction of pure aluminum with mineral acid at a similar level of acidity. The gas evolution could be stopped and restarted repeatedly simply by removing and then replacing the connection at the two ends of the copper wires. The gaseous product produced at the surface of the tungsten carbide sample was captured in soap bubbles and ignited. The explosion upon ignition strongly indicated the presence of elemental hydrogen in the product gas.

The foregoing experiments were carried out under ambient lighting conditions that included a mixture of artificial and natural light sources. When the reactions described were performed under decreased light conditions, the reaction rates generally decreased. However, separate formal testing under decreased lighting has not been performed.

It is believed the experimental results described above demonstrate the potential value of the invention described herein. The calculations are based on the reaction mechanisms described above and are believed to characterize the reactions involved in these experiments accurately. However, if it is discovered that the theories of reactions or the calculations based thereon are in error, the inventions described herein nevertheless are valid and valuable.

The embodiments shown and described above are exemplary. Many details are often found in the art and, therefore, many such details are neither shown nor described. It is not claimed that all of the details, parts, elements, or steps described and shown were invented herein. Even though numerous characteristics and advantages of the present invention have been described in the drawings and accompanying text, the description is illustrative only, and changes may be made in the detail, especially in matters of shape, size, and arrangement of the parts within the principles of the inventions to the full extent indicated by the broad meaning of the terms of the attached claims.

The restrictive description and drawings of the specific examples above do not point out what an infringement of this patent would be, but are to provide at least one explanation of how to use and make the inventions. The limits of the invention and the bounds of the patent protection are measured by and defined in the following claims.

1. An apparatus for the production of hydrogen comprising:
a reaction medium;
an anode in contact with the reaction medium;
a cathode in contact with the reaction medium, wherein the cathode is capable of being in conductive contact with the anode; and
a catalyst suspended in the reaction medium, wherein the catalyst has a high surface-area-to-volume ratio.

2. The apparatus of claim 1, wherein the catalyst is a colloidal metal.

3. The apparatus of claim 1, wherein the catalyst has a surface-area-to-volume ratio of at least 298,000,000 m² per cubic meter.

4. The apparatus of claim 1, wherein a salt is dissolved in the reaction medium.

5. The apparatus of claim 4, wherein a cation of the salt is less reactive than a metal composing the anode.

6. The apparatus of claim 4, wherein a cation of the salt comprises zinc or cobalt.

7. The apparatus of claim 1, further comprising a second catalyst suspended in the reaction medium, wherein the second catalyst is a colloidal metal or has a surface-area-to-volume ratio of at least 298,000,000 m² per cubic meter.

8. The apparatus of claim 1, wherein the anode and cathode are connected via a conductive path.

9. The apparatus of claim 8, wherein the conductive path is hardwired to the cathode and the anode.

10. The apparatus of claim 8, further comprising a controller in the conductive path between the cathode and the anode, wherein the controller is configured to selectively allow or hinder the flow of electrical current between the cathode and the anode through the conductive path.

11. The apparatus of claim 1, wherein the reaction medium is an aqueous solution.

12. The apparatus of claim 1, wherein the reaction medium comprises an acid or a base.

13. The apparatus of claim 1, wherein the cathode comprises tungsten carbide or carbonized nickel.

14. The apparatus of claim 1, wherein the anode comprises aluminum.

15. The apparatus of claim 1, wherein the cathode comprises surface-area-increasing features.

16. The apparatus of claim 1, wherein the surface area of the cathode is greater than the surface area of the anode.

17. The apparatus of claim 1, further comprising an energy source configured to provide energy to the reaction medium.

18. The apparatus of claim 1, wherein a reaction vessel containing the reaction medium is configured to maintain an internal pressure above atmospheric pressure.

19. The apparatus of claim 1, further comprising an electrical power source configured to provide an electrical potential between the cathode and the anode.

20. A battery comprising:
a reaction medium;
a first metal in contact with the reaction medium;
a first electrode comprising or in conductive contact with the first metal;
a second metal in contact with the reaction medium;
a second electrode comprising or in conductive contact with the second metal; and
a catalyst suspended in the reaction medium, wherein the catalyst has a relatively high surface-area-to-volume ratio.

21. The battery of claim 20, wherein the catalyst is a colloidal metal.

22. The battery of claim 20, wherein the catalyst has a surface-area-to-volume ratio of at least 298,000,000 m² per cubic meter.

23. The battery of claim 20, further comprising a second catalyst in contact with the reaction medium, wherein the second catalyst is in colloidal form or has a surface-area-to-volume ratio of at least 298,000,000 m² per cubic meter.

24. The battery of claim 20, wherein a salt is dissolved in the reaction medium.

25. The battery of claim 24, wherein a cation of the salt is less reactive than a metal composing the second metal.

26. The battery of claim 20, wherein the reaction medium comprises an acid or a base.

27. A method of producing hydrogen gas comprising the steps of:
suspending a colloidal metal in a reaction medium;
contacting the reaction medium with a cathode;
contacting the reaction medium with an anode; and
electrically connecting the cathode and the anode.

28. The method of claim 27, further comprising the step of dissolving a salt in the reaction medium.

29. The method of claim 27, further comprising the steps of:
interrupting the conductive path between the anode and cathode; and
providing an electrical potential between the anode and cathode.

30. The method of claim 27, further comprising the step of adding energy to the reaction medium.

31. A method of controlling the production of hydrogen comprising the steps of:
suspending a colloidal metal in a reaction medium;
contacting the reaction medium with a cathode;
contacting the reaction medium with an anode;
connecting the cathode and the anode via a conductive path; and
varying the resistance along the conductive path.

32. An electrical power generator comprising:
a reaction vessel;
a reaction medium contained within the reaction vessel;
an anode in contact with the reaction medium;
a cathode in contact with the reaction medium, wherein the cathode is in conductive contact with the anode;
a catalyst metal in contact with the reaction medium, wherein the catalyst metal is in colloidal form or has a surface-area-to-volume ratio of at least 298,000,000 m² per cubic meter;
an outlet in the reaction vessel configured to allow hydrogen gas to escape from the reaction vessel; and
a fuel cell configured to accept hydrogen from the outlet and use the gas to produce an electric potential.
